(19) United States
(12) Patent Application Publication
(10) Pub. No.: US 2026/0100414 A1
(43) Pub. Date: Apr. 9, 2026

(54) FLAME-RETARDANT OR NON-FLAMMABLE POLYMER GEL ELECTROLYTE, LITHIUM BATTERY INCLUDING THE SAME, SUPRAMOLECULAR POLYMER, AND METHOD OF PREPARING THE SUPRAMOLECULAR POLYMER

(71) Applicant: The Industry & Academic Cooperation in Chungnam National University (IAC), Daejeon (KR)

(72) Inventors: Seung-Wan SONG, Daejeon (KR); Woo-Jin Song, Daejeon (KR); Chi Keung Song, Daejeon (KR); Kihun An, Daejeon (KR)

(73) Assignee: The Industry & Academic Cooperation in Chungnam National University (IAC), Daejeon (KR)

(21) Appl. No.: 19/032,926

(22) Filed: Jan. 21, 2025

(30) Foreign Application Priority Data
Oct. 7, 2024 (KR) 10-2024-0136011

(51) Int. Cl. H01M 10/0565; C08J 3/075; C08K 3/105; C08K 5/1545; C08K 5/1565; H01M 10/0525

(52) U.S. Cl. CPC H01M 10/0565; C08J 3/075; C08K 3/105; C08K 5/1545; C08K 5/1565; C08J 2333/16; H01M 10/0525; H01M 2300/0085

(57) ABSTRACT

Provided are a flame-retardant or non-flammable polymer gel electrolyte, a lithium battery including the same, a supramolecular polymer, and a method of preparing the supramolecular polymer, the flame-retardant or non-flammable polymer gel electrolyte including a supramolecular polymer, a carbonate-based solvent, a fluorine-containing linear ester-based solvent, and a lithium salt, wherein the supramolecular polymer includes a hard segment and a soft segment, the hard segment and the soft segment are connected by a urethane bond, a urea bond or a combination thereof, the soft segment includes an alkylene oxide repeating unit, and the supramolecular polymer has a glass transition temperature (Tg) of less than 0° C.

### CROSS-REFERENCE TO RELATED APPLICATION

This application is based on and claims priority under 35 U.S.C. § 119 to Korean Patent Application No. 10-2024-0136011, filed on Oct. 7, 2024, in the Korean Intellectual Property Office, the disclosure of which is incorporated by reference herein in its entirety.

### BACKGROUND

### 1. Field

The disclosure relates to a polymer gel electrolyte, a lithium battery including the polymer gel electrolyte, a supramolecular polymer, and a method of preparing the supramolecular polymer.

This study was conducted with the support of the Samsung Future Technology Promotion Project (Project Number: SRFC-MA-2202-04).

### 2. Description of the Related Art

Recently, the development of batteries with high energy density and safety has been actively conducted. Lithium batteries are used in a variety of applications, including information devices, communication devices, and automobiles. Safety is important in automobiles.

Lithium batteries using liquid electrolytes may have an increased risk of fire and/or explosion in the event of a short circuit.

Solid electrolytes have lower flammability and combustibility than liquid electrolytes. In lithium batteries including solid electrolytes, the possibility of fire or explosion can be reduced. But, solid electrolytes have lower ionic conductivity and higher interfacial resistance than liquid electrolytes.

Lithium metal may be used as an anode material. The theoretical capacity of lithium metal is 3860 mAh/g. The lifespan characteristics of a lithium metal battery including lithium metal anode may deteriorate due to volume changes and unstable interface during charge-discharge.

### SUMMARY

Liquid electrolytes can cause side reactions with lithium metal during a charge-discharge process of lithium batteries. The lifespan characteristics of lithium batteries including liquid electrolytes may deteriorate, and there is a high possibility of ignition.

Solid electrolytes may have difficulty in effectively accommodating changes in the volume of lithium metal during the charge-discharge process of lithium batteries, and may have difficulty in maintaining adhesion when the volume of lithium metal changes. The lifespan characteristics of lithium batteries including solid electrolytes may deteriorate. Inorganic solid electrolytes have relatively high ionic conductivity, but are brittle and prone to cracking. Lithium dendrites can grow through such cracking, thereby causing short circuits. Polymer solid electrolytes with increased ionic conductivity may have somewhat deteriorated mechanical properties, thus making it difficult to prevent the formation of dendrites and short circuit. Polymer solid electrolytes with increased mechanical properties may cause cracking by forming rigid electrolytes.

There are needs of a novel electrolyte and a lithium battery including the same, the novel electrolyte being able to suppress the possibility of ignition and side reactions of known liquid electrolytes and prevent the cracking and low ionic conductivity of solid electrolytes.

An aspect is to provide a flame-retardant or non-flammable polymer gel electrolyte which simultaneously provides a reduced ignition possibility, excellent ionic conductivity, and low viscosity.

Another aspect is to provide a lithium battery having improved charge/discharge characteristics and improved safety by employing the above-described flame retardant or non-flammable polymer gel electrolyte.

Another aspect is to provide a supramolecular polymer that can simultaneously provide excellent ionic conductivity and mechanical properties.

Another aspect is to provide a method of preparing a novel supramolecular polymer.

Additional aspects will be set forth in part in the description which follows and, in part, will be apparent from the description, or may be learned by practice of the presented embodiments of the disclosure.

According to an embodiment, a flame-retardant or non-flammable polymer gel electrolyte includes
a supramolecular polymer,
a carbonate-based solvent,
a fluorine-containing linear ester-based solvent, and
a lithium salt,
wherein the supramolecular polymer includes a hard segment and a soft segment,
the hard segment and the soft segment are connected by a urethane bond, a urea bond or a combination thereof,
the soft segment includes an alkylene oxide repeating unit, and
the supramolecular polymer has a glass transition temperature (Tg) of less than 0° C.

According to another embodiment, a lithium battery includes
a cathode, an anode, and
an electrolyte layer between the cathode and the anode,
wherein the electrolyte layer includes the flame-retardant or non-flammable polymer gel electrolyte.

According to another embodiment, a supramolecular polymer includes
at least one selected from a repeating unit represented by Formula 1 below, a compound represented by Formula 2 below, a repeating unit derived from the compound represented Formula 2, and a reaction product derived from the compound represented by Formula 2,

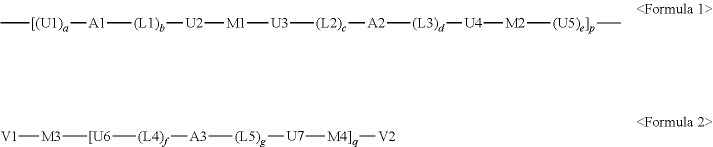

wherein, in Formulae 1 and 2,
M1, M2, M3 and M4 are each independently an arylene group selected from the arylene groups represented by Formulae 3a to 3d below or a cycloalkylene group selected from the cycloalkylene groups represented by Formulae 3e to 3g below,
U1, U2, U3, U4, U5, U6 and U7 are each independently —NH—C(═O)O—, —OC(═O)—NH—, —C(═O)—NH—, —NH—C(═O)—, —NH—C(═O)—NH—, —NH— or —O—,
V1 and V2 are each independently an isocyanate group,
L1, L2, L3, L4 and L5 are each independently a C2-C5 alkylene group,
A1, A2 and A3 are each independently a C2-C5 alkylene oxide repeating unit,
a, b, c, d, e, f, g, h and i are each independently 0 or 1,

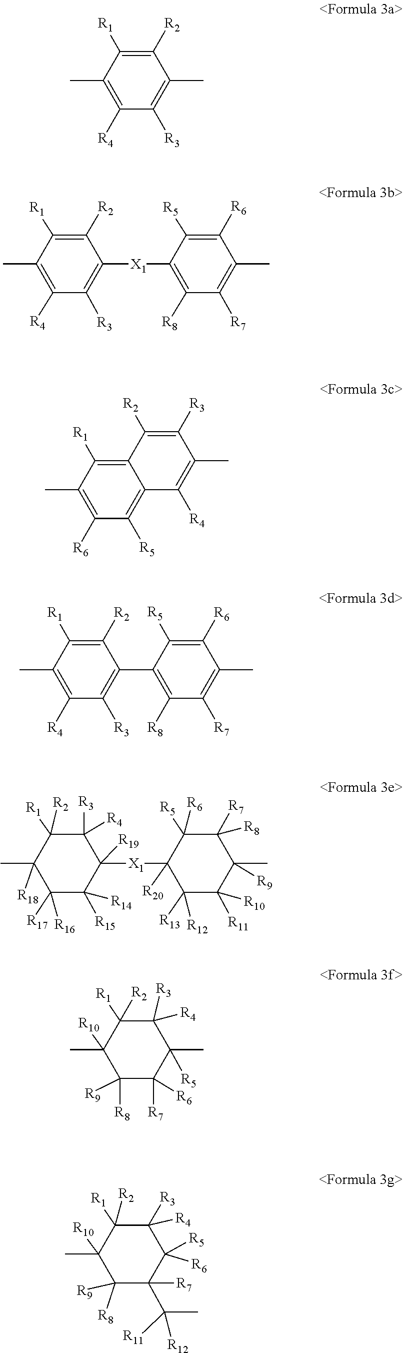

wherein, in Formulae 3a to 3g,
R₁, R₂, R₃, R₄, R₅, R₆, R₇, R₈, R₉, R₁₀, R₁₁, R₁₂, R₁₃, R₁₄, R₁₅, R₁₆, R₁₇, R₁₈, R₁₉ and R₂₀ are each independently hydrogen, a halogen, a hydroxyl group, or a C1-C10 alkyl group unsubstituted or substituted with a halogen,
X₁ is —CH₂—, —CH₂CH₂—, —CH₂CH₂CH₂—, —CH₂CH₂CH₂CH₂—, —O—, —C(═O)—, —S—, or —C(═S)—,
p is a polymerization degree of 2 to 1000, and
q is a polymerization degree of 1 to 1000.

According to another embodiment, a method of preparing a supramolecular polymer includes
reacting a first precursor compound including a soft segment, a first solution including a first solvent, and a second precursor compound including a hard segment to prepare a prepolymer, and
reacting a third precursor compound including a spacer, a second solution including a second solvent, and the prepolymer to prepare a supramolecular polymer,
wherein the first solvent and the second solvent have a first volume ratio in which 70 parts by volume or less of the second solvent is included with respect to 100 parts by volume of the first solvent, or a second volume ratio in which 80 parts by volume or more of the second solvent is included with respect to 100 parts by volume of the first solvent, and
viscosity of a first supramolecular polymer prepared by the first volume ratio is 50% or less of viscosity of a second supramolecular polymer prepared by the second volume ratio.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a view illustrating infrared spectra of a supramolecular polymer prepared in Preparation Example 3;

FIG. 2 is a view illustrating NMR spectra of supramolecular polymers prepared in Preparation Examples 3 and 4;

FIG. 3A is a photograph illustrating a cross-sectional image of an anode of Example 17 after 100 charge-discharge cycles;

FIG. 3B is a partially enlarged view of FIG. 3A;

FIG. 3C is a photograph illustrating a cross-sectional image of an anode of Comparative Example 4 after 100 charge-discharge cycles;

FIG. 3D is a partially enlarged view of FIG. 3C;

FIG. 4A is a photograph illustrating a cross-sectional image of a cathode of Example 17 after 100 charge-discharge cycles;

FIG. 4B is a partially enlarged view of FIG. 4A;

FIG. 4C is a photograph illustrating a cross-sectional image of a cathode of Comparative Example 4 after 100 charge-discharge cycles;

FIG. 4D is a partially enlarged view of FIG. 4C;

FIG. 5 is a schematic view of a lithium battery according to an embodiment;

FIG. 6 is a schematic view of a lithium battery according to an embodiment;

FIG. 7 is a schematic view of a lithium battery according to an embodiment; and

FIG. 8 is a schematic view of a lithium battery according to an embodiment;

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Unless otherwise defined, all terms (including technical and scientific terms) used in this disclosure have the same meaning as that commonly understood by those skilled in the art to which this disclosure belongs. Additionally, terms defined in commonly used dictionaries should be interpreted as having a meaning consistent with their meaning within the context of the relevant art and the present disclosure, and should not be interpreted in an idealized or overly formal sense.

Exemplary embodiments are described in the present disclosure with reference to cross-sectional views which are schematic diagrams of idealized embodiments. Likewise, for example, variations in the illustrated shape must be expected as a result of manufacturing techniques and/or tolerances. Therefore, the embodiments described in this disclosure should not be construed as limited to the specific shapes of regions as illustrated in this disclosure, and should include, for example, deviations in shapes resulting from manufacturing. For example, a region illustrated or described as flat may typically have rough and/or non-linear features. Moreover, sharply illustrated angles may be rounded. Accordingly, the regions illustrated in the drawings are schematic in nature, and their shapes are not intended to illustrate the precise shape of the regions and are not intended to limit the scope of the claims.

This inventive idea may be embodied in many different forms, and should not be construed as limited to the embodiments described in this disclosure. Embodiments are provided so that this disclosure will be thorough and complete, and are provided to fully transfer the scope of the inventive idea to those skilled in the art. Identical drawing symbols indicate identical components.

When a component is referred to as being located “on or over” another component, it can be understood that it may be located directly on another component, or that another component may intervene therebetween. In contrast, when a component is referred as being located “directly on” another component, no component may intervene therebetween.

Although the terms “first,” “second,” “third,” etc. may be used herein to describe various components, ingredients, areas, layers, and/or regions, these components, ingredients, areas, layers, and/or regions should not be limited by these terms. These terms are used only to distinguish one component, ingredient, area, layer or region from another component, ingredient, area, layer or region. Accordingly, the first component, ingredient, area, layer or region, described below, may be referred to as a second component, ingredient, area, layer or region without departing from the scope of the present disclosure.

The terms used in this disclosure are for the purpose of describing only particular embodiments and are not intended to limit the inventive idea. As used herein, the singular form is intended to include the plural form including “at least one,” unless the context clearly dictates otherwise. “At least one” should not be construed as limiting to the singular number. As used herein, the term “and/or” includes any and all combinations of one or more of the listed items. The terms “include” and/or “including” as used in the detailed description specify the presence of stated features, regions, integers, steps, operations, components and/or ingredients, but do not preclude the presence or addition of one or more other features, regions, integers, steps, operations, components, ingredients and/or groups thereof.

Spatially relative terms such as “bottom,” “below,” “lower,” “upper,” “top,” etc. may be used herein to facilitate the description of the relationship of one component or feature to another component or feature. It will be understood that spatially relative terms are intended to encompass different directions of a device when used or operated in addition to the directions illustrated in the drawings. For example, if the device in the drawing overturn, a component described as being “beneath” or “under” another component or feature would be oriented “over” the other component or feature. Thus, the exemplary term “under” may encompass both the upward and downward directions. The above device may be located in other directions (rotated 90 degrees or otherwise), and the spatially relative terms used in this disclosure may be interpreted accordingly.

“Group” refers to a group in the periodic table of the elements according to the International Union of Pure and Applied Chemistry (“IUPAC”) Group 1-18 classification system.

As used herein, the “particle diameter” refers to an average diameter when a particle is spherical, and refers to an average major axis length when the particle is non-spherical. The particle diameter may be measured using a particle size analyzer (PSA). “Particle diameter” is, for example, an average particle diameter. “Average particle diameter” is, for example, a median particle diameter, D50.

D50 is a size of the particle corresponding to 50% of the cumulative volume, calculated from the side of the particle with the smaller particle size in the size distribution of the particles measured by laser diffraction.

D90 is a size of the particle corresponding to 90% of the cumulative volume, calculated from the side of the particle with the smaller particle size in the size distribution of the particles measured by laser diffraction.

D10 is a size of the particle corresponding to 10% of the cumulative volume, calculated from the side of the particle with the smaller particle size in the size distribution of the particles measured by laser diffraction.

As used herein, the “metal” includes both metals and metalloids such as silicon and germanium, under an elemental state or an ionic state.

As used herein, the “alloy” refers to a mixture of two or more metals.

As used herein, the “electrode active material” refers to an electrode material capable of undergoing lithiation and delithiation.

As used herein, the “cathode active material” refers to a cathode material capable of undergoing lithiation and delithiation.

As used herein, the “anode active material” refers to an anode material capable of undergoing lithiation and delithiation.

As used herein, the “lithiation” and “lithiating” refers to a process of adding lithium to an electrode active material.

As used herein, the “delithiation” and “delithiate” refers to a process of removing lithium from an electrode active material.

As used herein, the “charge” and “charging” refers to a process of providing electrochemical energy to a battery.

As used herein, the “discharge” and “discharging” refers to a process of removing electrochemical energy to a battery.

As used herein, the “positive electrode” and “cathode” refers to an electrode at which electrochemical reduction and lithiation occur during a discharge process.

As used herein, the “negative electrode” and “anode” refers to an electrode at which electrochemical oxidation and delithiation occur during a discharge process.

Although specific embodiments have been described, alternatives, modifications, variations, improvements, and substantial equivalents, which are not currently anticipated or cannot be anticipated, may occur to applicants or those skilled in the art. Accordingly, the appended claims, as filed and as amended, are intended to encompass all such alternatives, modifications, variations, improvements and substantial equivalents.

Hereinafter, flame-retardant or non-flammable polymer gel electrolytes, lithium batteries including the same, supramolecular polymers, and methods of preparing the same according to embodiments will be described in more detail.

### [Polymer Gel Electrolyte]

A flame-retardant or non-flammable polymer gel electrolyte according to an embodiment includes a supramolecular polymer, a carbonate-based solvent, a fluorine-containing linear ester-based solvent, and a lithium salt. The supramolecular polymer includes a hard segment and a soft segment. The hard segment and the soft segment are connected by a urethane bond, a urea bond, or a combination thereof. The soft segment includes an alkylene oxide repeating unit. The supramolecular polymer has a glass transition temperature (Tg) of less than 0° C.

The flame-retardant or non-flammable polymer gel electrolyte can simultaneously provide reduced ignition possibility, excellent ionic conductivity and low viscosity. Since the flame-retardant or non-flammable polymer gel electrolyte has reduced ignition possibility, the ignition possibility of a lithium battery can be suppressed. Since the flame-retardant or non-flammable polymer gel electrolyte has low viscosity, it can be easily impregnated onto the surface of a cathode active material and/or an anode active material. Since the flame-retardant or non-flammable polymer gel electrolyte has excellent ionic conductivity, the increase in internal resistance of a lithium battery can be suppressed, and the reversibility of an electrode reaction can be improved. The flame-retardant or non-flammable polymer gel electrolyte can form a uniform protective layer/solid electrolyte interphase (SEI) on the surface of a cathode active material and/or an anode active material during the charge/discharge process of a lithium battery. Since the protective layer/solid electrolyte interphase (SEI) includes a supramolecular polymer and/or a component derived therefrom, the structural stability of the protective layer/solid electrolyte interphase (SEI) can be improved. A uniform and stable protective layer/solid electrolyte interface (SEI) can effectively suppress side reactions on the surface of a cathode active material and/or an anode active material. In particular, since lithium dendrite formation and resulting short-circuit are prevented by the formation of a uniform and stable protective layer/solid electrolyte membrane (SEI) on the surface of an anode active material, the charge/discharge characteristics and safety of a lithium battery including a flame-retardant or non-flammable polymer gel electrolyte can be improved.

The supramolecular polymer is a polymer having a polymeric arrangement in which repeating units and/or monomer units are connected to each other by reversible non-covalent bonds. The non-covalent bond includes, for example, van der Waals interactions, hydrogen bonding, Coulomb or ionic interactions, π-π stacking, and host-guest interactions. The supramolecular polymer can provide both excellent material properties and low viscosity. Since the supramolecular polymers are three-dimensionally connected by reversible non-covalent bonds, they can self-heal cracks or the like caused by external pressure. The polymer gel electrolyte including the supramolecular polymer can self-heal cracks or the like caused by the change in volume of a lithium battery during the charging and discharging. Therefore, the polymer gel electrolyte including the supramolecular polymer can effectively suppress an increase in internal resistance and/or interfacial resistance due to cracks, etc. during the charge/discharge process of a lithium battery. As a result, deterioration of a lithium battery including the polymer gel electrolyte can be suppressed.

The supramolecular polymer includes a hard segment and a soft segment.

The hard segment can provide structural stability to the supramolecular polymer. Since the supramolecular polymer includes the hard segment, the mechanical properties of the supramolecular polymer can be improved. The hard segment may have lower ionic conductivity than the soft segment or may have virtually no ionic conductivity.

The hard segment may include, for example, an aromatic ring, an aliphatic ring, or a combination thereof. The aromatic ring, aliphatic ring, etc. can provide structural stability to the supramolecular polymer.

The aromatic ring and/or the aliphatic ring may have a skeleton including carbon atoms. For example, the skeleton of the aromatic ring and/or aliphatic ring may include only carbon atoms and may not include heteroatoms such as nitrogen, oxygen, or sulfur. The aromatic ring may be, for example, an aromatic carbon ring having 5 to 20 carbon atoms or an aromatic carbon ring having 5 to 10 carbon atoms. The aliphatic ring may be, for example, an aliphatic carbon ring having 5 to 20 carbon atoms or an aliphatic carbon ring having 5 to 10 carbon atoms. The aromatic ring may include, for example, an aryl group or an arylene group.

Alternatively, the aromatic ring and/or the aliphatic ring may additionally include heteroatoms in addition to carbon atoms. For example, the skeleton of the aromatic ring and/or aliphatic ring may additionally include heteroatoms such as nitrogen, oxygen, sulfur, and the like in addition to carbon atoms. The aromatic ring may be, for example, an aromatic heterocyclic ring having 2 to 20 carbon atoms or an aromatic heterocyclic ring having 2 to 10 carbon atoms. The aliphatic ring may be, for example, an aliphatic heterocyclic ring having 2 to 20 carbon atoms or an aliphatic heterocyclic ring having 2 to 10 carbon atoms. The aromatic heterocyclic ring may include, for example, a heteroaryl group, a heteroarylene group, or a combination thereof.

Since the supramolecular polymer includes a soft segment, the ionic conductivity of the supramolecular polymer can be improved. The soft segment may have higher ionic conductivity than the hard segment. The soft segment may have lower mechanical properties than the hard segment. Since the supramolecular polymer includes the soft segment, the supramolecular polymer can have improved flexibility and reduced viscosity.

The soft segment includes an alkylene oxide repeating unit. Since the soft segment has an alkylene oxide repeating unit, the ionic conductivity of the supramolecular polymer can be improved.

The alkylene oxide repeating unit may include, for example, a C2-C5 alkylene oxide repeating unit. The alkylene oxide repeating unit may include, for example, an ethylene oxide repeating unit, a propylene oxide repeating unit, a butylene oxide repeating unit, or a combination thereof.

The supramolecular polymer includes a hard segment and a soft segment, and the hard segment and the soft segment are connected by a urethane bond, a urea bond, or a combination thereof.

A urethane group, a urea group or a combination thereof may be placed between the hard segment and the soft segment. Since the hard segment and the soft segment are connected by a urethane bond, a urea bond, or a combination thereof, the supramolecular polymer may form a block copolymer. The supramolecular polymer may be a block copolymer including a first block constituting the hard segment and a second block constituting the soft segment. The supramolecular polymer may be, for example, a block copolymer including a first block having structural stability and a second block having ionic conductivity. The supramolecular polymer may be, for example, a block copolymer having a structure in which structural first blocks and ion-conducting second blocks are arranged alternately. The supramolecular polymer may be, for example, a block copolymer having a structure in which structural channels formed by structural first blocks and ion-conducting channels formed by ion-conducting second blocks are arranged alternately. Since the supramolecular polymer has such a block copolymer structure, the relative contents of the structural first blocks and the ion-conducting second blocks can be easily changed. The properties of the supramolecular polymer can be easily controlled by changing the relative contents of the structural first blocks and the ion-conducting second blocks.

The supramolecular polymer includes a hard segment and a soft segment, and may further include a lithium salt. The lithium salt may be placed in the soft segment of the supramolecular polymer. In the supramolecular polymer, the lithium salt may be selectively placed in the soft segment. The supramolecular polymer may include an ion-conducting soft segment and an ion-insulating hard segment. The ionic conductivity of the supramolecular polymer can be improved by including a lithium salt in the soft segment. Since the lithium salt is placed in the soft segment of the supramolecular polymer, the supramolecular polymer can simultaneously provide improved ionic conductivity and excellent mechanical properties.

The supramolecular polymer may further include a spacer.

Since the supramolecular polymer further includes a spacer, the molecular weight of the supramolecular polymer increases, and thus the flexibility of the supramolecular polymer can increase. Since the supramolecular polymer further includes a spacer, the ionic conductivity of the supramolecular polymer can be further improved The supramolecular polymer including a spacer may have improved flexibility and reduced viscosity as compared with supramolecular polymers not including a spacer of the same molecular weight. The spacer may have a structure identical to or distinct from the soft segment.

The spacer may include, for example, an alkylene oxide repeating unit. The spacer may include, for example, a C2-C5 alkylene oxide repeating unit. The spacer may include, for example, an ethylene oxide repeating unit, a propylene oxide repeating unit, a butylene oxide repeating unit, or a combination thereof.

The spacer may include, for example, at least one selected from a repeating unit represented by Formula 1 below, a compound represented by Formula 2 below, a repeating unit derived from the compound represented Formula 2, and a reaction product derived from the compound represented by Formula 2. The reaction product derived from the compound represented by Formula 2 may include, for example, a compound represented by Formula 2-1 below.

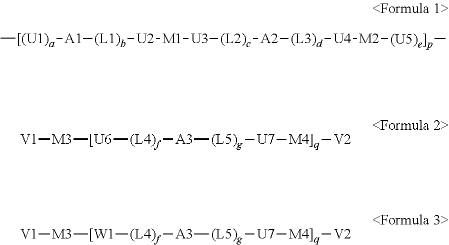

wherein
W1 is

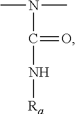

and
Rₐ is -M5-[U8-(L6)ₕ-A4-(L7)ᵢ-U9-M6]ᵣ—V3.

In Formulae 2 and 2-1,
M1, M2, M3, M4, M5 and M6 are each independently an arylene group selected from the arylene groups represented by Formulae 3a to 3d below or a cycloalkylene group selected from the cycloalkylene groups represented by Formulae 3e to 3g,
U1, U2, U3, U4, U5, U6, U7, U8 and U9 are each independently —NH—C(═O)O—, —OC(═O)—NH—, —C(═O)—NH—, —NH—C(═O)—, —NH—C(═O)—NH—, —NH—, or —O—,
V1, V2 and V3 are each independently an isocyanate group,
L1, L2, L3, L4, L5, L6 and L7 are each independently a C2-C5 alkylene group,
A1, A2, A3 and A4 are each independently a C2-C5 alkylene oxide repeating unit, and
a, b, c, d, e, f, g, h and i are each independently 0 or 1.

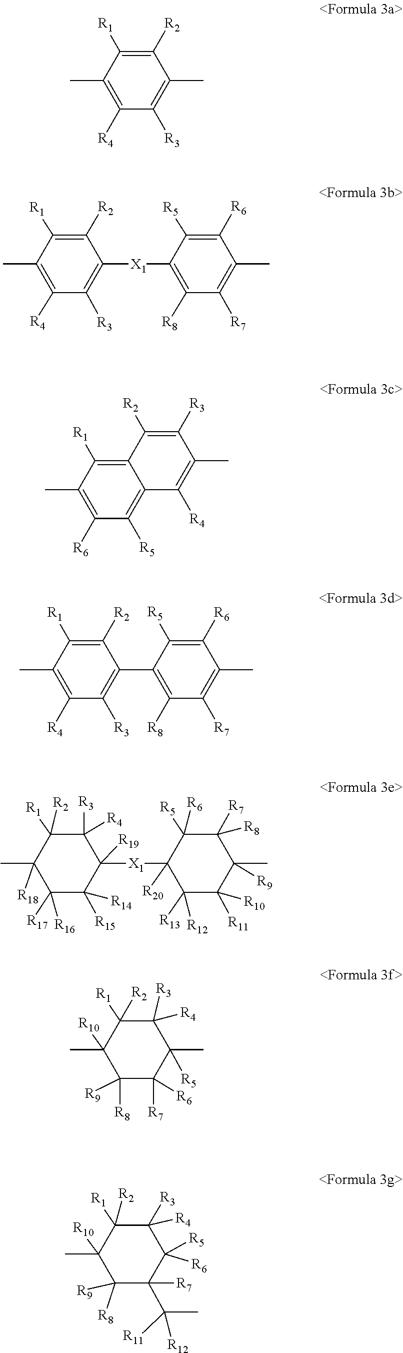

In Formulae 3a to 3g,
R₁, R₂, R₃, R₄, R₅, R₆, R₇, R₈, R₉, R₁₀, R₁₁, R₁₂, R₁₃, R₁₄, R₁₅, R₁₆, R₁₇, R₁₈, R₁₁ and R₂₀ are each independently hydrogen, a halogen, a hydroxyl group, or a C1-C10 alkyl group unsubstituted or substituted with a halogen,
X₁ is —CH₂—, —CH₂CH₂—, —CH₂CH₂CH₂—, —CH₂CH₂CH₂CH₂—, —O—, —C(═O)—, —S—, or —C(═S)—,
p is a polymerization degree of 2 to 1000,
q and r are each independently a polymerization degree of 1 and 1000.

Since the supramolecular polymer has such a structure, the polymer gel electrolyte including the supramolecular polymer can provide both excellent ionic conductivity and low viscosity. Since the supramolecular polymer has such a structure, the charge/discharge characteristics of a lithium battery including the supramolecular polymer can be further improved.

The supramolecular polymer includes, for example, a repeating unit represented by Formula 1, or a compound represented by Formula 2 or a reaction product thereof, wherein, in the repeating unit represented by Formula 1, or the compound represented by Formula 2 or the reaction product thereof, L1, L2, L3, L4, L5, L6, and L7 may be each independently —CH₂CH₂—, —CH₂CH₂CH₂—, or —CH₂CH(CH₃)—.

The supramolecular polymer includes, for example, a repeating unit represented by Formula 1, or a compound represented by Formula 2 or a reaction product thereof, wherein, in the repeating unit represented by Formula 1, or the compound represented by Formula 2 or the reaction product thereof, A1, A2, A3, and A4 may be each independently —(CH₂CH₂O)ₙ₁—, —(CH₂CH(CH₃)O)ₙ₂—, —(CH₂CH₂)ₙ₃—(CH₂CH(CH₃)O)ₙ₄—, —(CH₂CH₂)ₙ₅—(CH₂CH(CH₃)O)ₙ₆—(CH₂CH₂)ₙ₇—, or —(CH₂CH(CH₃)O)ₙ₈—(CH₂CH₂)ₙ₉—(CH₂CH(CH₃)O)ₙ₁₀—, and n1, n2, n3, n4, n5, n6, n7, n8, n9 and n10 may be each independently 2 to 500.

The supramolecular polymer includes, for example, a repeating unit represented by Formula 1, or a compound represented by Formula 2 or a reaction product thereof, wherein, in the repeating unit represented by Formula 1, or the compound represented by Formula 2 or the reaction product thereof, M1, M2, M3, M4, M5 and M6 may be each independently an arylene group selected from the arylene groups represented by Formulae 4a to 4d below or a cycloalkylene group selected from the cycloalkylene groups represented by Formulae 4e to 4g:

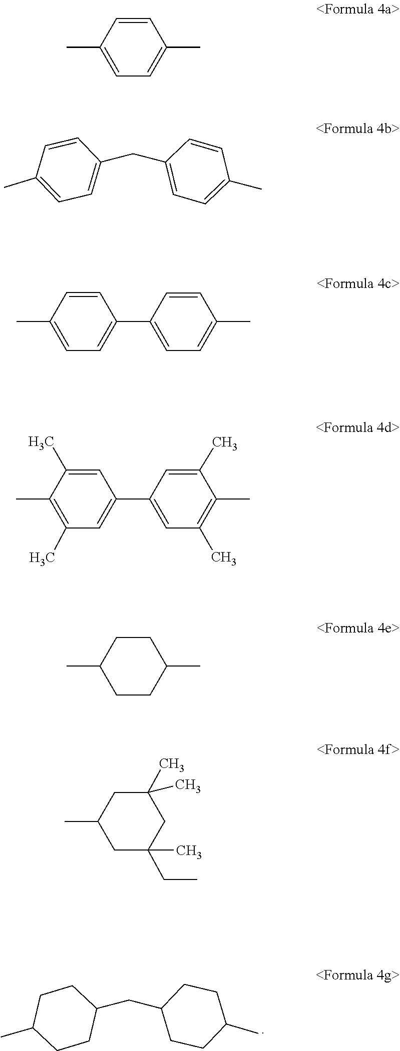

The supramolecular polymer may include, for example, a repeating unit represented by Formula 5 below, a repeating unit represented by Formula 7 below, a compound represented by Formula 6 below, or a compound represented by Formula 8 below:

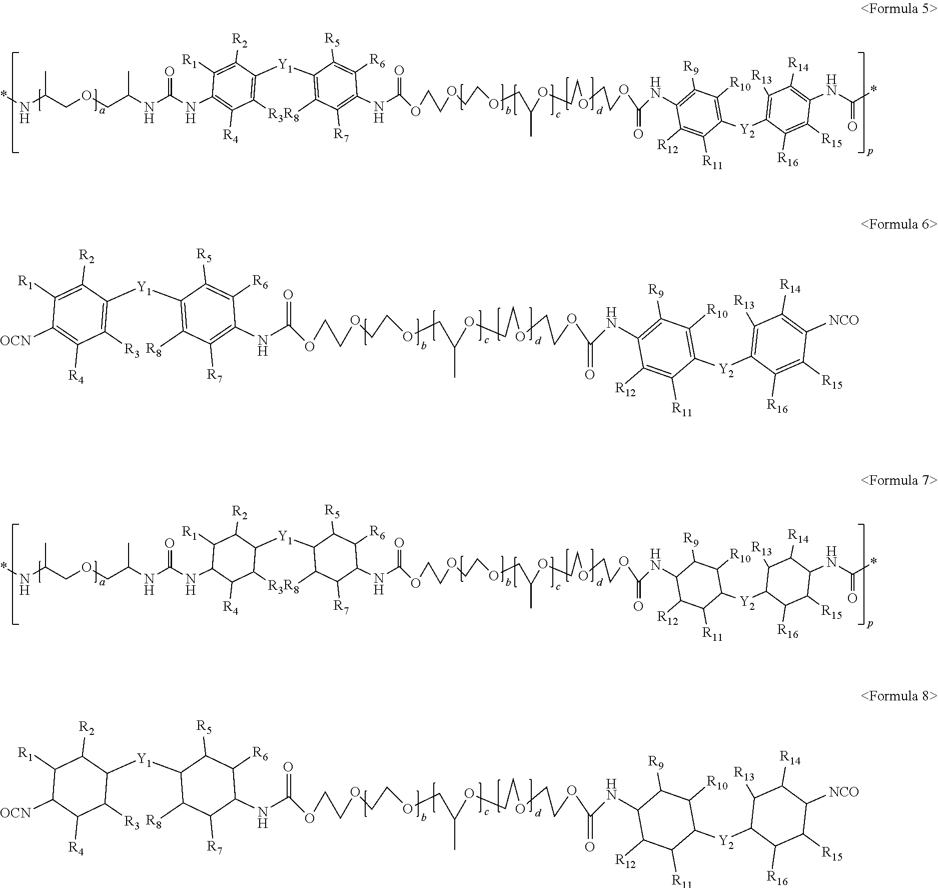

wherein, in Formulae 5 to 8,
R₁, R₂, R₃, R₄, R₅, R₆, R₇, R₈, R₉, R₁₀, R₁₁, R₁₂, R₁₃ and R₁₄ are each independently hydrogen, a halogen, a hydroxyl group, or a C1-C5 alkyl group unsubstituted or substituted with a halogen,

Y₁ and Y₂ are each independently a single bond, —CH₂—, —CH₂CH₂—, —H₂CH₂CH₂—, —CH₂CH₂CH₂CH₂—, —O—, —C(═O)—, —S—, or —C(═S)—,
a, b, c and d are each independently 2 to 500, and
p is a polymerization degree of 2 to 1000.

The supramolecular polymer may include, for example, a repeating unit represented by Formula 9 below, a repeating unit represented by Formula 11 below, a compound represented by Formula 10 below, or a compound represented by Formula 12 below:

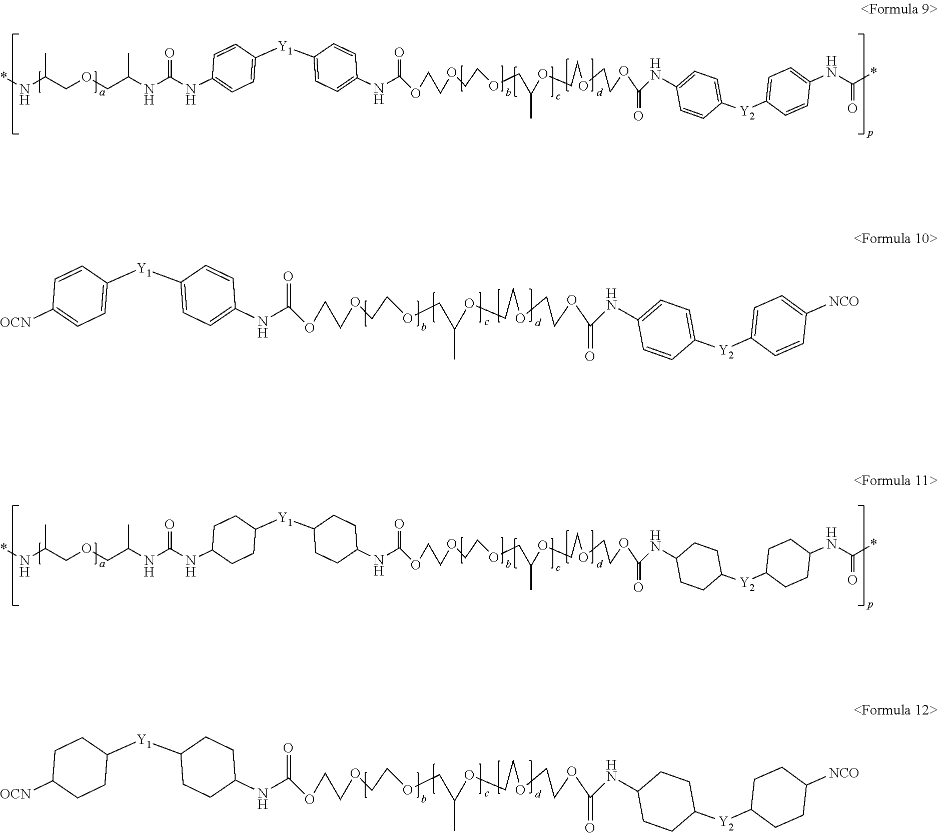

wherein, in Formulae 9 to 12,
Y₁ and Y₂ are independently a single bond, —CH₂—, —CH₂CH₂—, —CH₂CH₂CH₂—, —CH₂CH₂CH₂CH₂—, —O—, —C(═O)—, —S—, or —C(═S)—,
a, b, c and d are each independently 2 to 500, and
p is a polymerization degree of 2 to 1000.

The weight average molecular weight of the supramolecular polymer may be, for example, about 5,000 Dalton to about 500,000 Dalton, about 7,000 Dalton to about 300,000 Dalton, about 8,000 Dalton to about 200,000 Dalton, about 10,000 Dalton to about 100,000 Dalton, about 20,000 Dalton to about 80,000 Dalton, about 25,000 Dalton to about 70,000 Dalton or about 30,000 Dalton to about 50,000 Dalton. Since the supramolecular polymer has a weight average molecular weight in this range, the charge/discharge characteristics of a lithium battery including the supramolecular polymer can be further improved. The weight average molecular weight of the supramolecular polymer may be measured for a polystyrene standard sample using gel permeation chromatography.

The glass transition temperature (Tg) of the supramolecular polymer is less than 0° C.

The glass transition temperature (Tg) of the supramolecular polymer may be, for example, −10° C. or less, −20° C. or less, −30° C. or less, −40° C. or less, −50° C. or less, −55° C. or less, −60° C. or less, or −65° C. or less.

The glass transition temperature (Tg) of the supramolecular polymer may be, for example, about −200° C. to about −10° C., about −200° C. to about −20° C., about −200° C. to about −30° C., about −200° C. to about −40° C., about −200° C. to about −50° C., about −150° C. to about −55° C., about −120° C. to about −60° C., or about −100° C. to about −65° C. Since the supramolecular polymer has such a low glass transition temperature, the supramolecular polymer may have reduced viscosity. Further, since the supramolecular polymer has such a low glass transition temperature, the supramolecular polymer can provide increased ionic conductivity as a polymer gel electrolyte. The glass transition temperature of the supramolecular polymer may be measured, for example, by differential scanning calorimetry.

The viscosity of the supramolecular polymer may be, for example, about 1000 mPa·s to about 1,000,000 mPa·s, about 1000 mPa·s to about 500,000 mPa·s, about 1000 mPa·s to about 300,000 mPa·s, about 2000 mPa·s to about 150,000 mPa·s, about 2000 mPa·s to about 100,000 mPa·s, or about 2000 mPa·s to about 60,000 mPa·s. Since the supramolecular polymer has viscosity in this range, the supramolecular polymer can simultaneously provide high ionic conductivity and excellent mechanical properties. Since the supramolecular polymer has viscosity in this range, the charge/discharge characteristics of a lithium battery including the supramolecular polymer can be improved. The viscosity of the supramolecular polymer may be measured using a rheometer or a viscometer.

The content of the supramolecular polymer may be, for example, 1 wt % to 50 wt %, 1 wt % to 30 wt %, 1 wt % to 20 wt %, 1 wt % to 15 wt %, or 5 wt % to 12 wt % based on the total weight of the flame-retardant or non-flammable polymer gel electrolyte.

Since the flame-retardant or non-flammable polymer gel electrolyte has a supramolecular polymer content in this range, the charge/discharge characteristics of a lithium battery including the polymer gel electrolyte can be improved.

The flame-retardant or non-flammable polymer gel electrolyte includes a lithium salt.

Since the flame-retardant or non-flammable polymer gel electrolyte includes a lithium salt, the ionic conductivity of the flame-retardant or non-flammable polymer gel electrolyte can be improved.

The lithium salt may include, for example, LiPF₆, LiBF₄, LiSbF₆, LiAsF₆, LiClO₄, LiAlO₂, LiAlCl₄, LiCF₃SO₃, LiC₆H₅SO₃, LiC₄F₉SO₃, Li(FSO₂)₂N, Li(CF₃SO₂)₂N, Li(C₂F₅SO₃)₂N, Li(C₂F₅SO₂)₂N, LiN(CₓF₂ₓ₊₁SO₂)(C_{y}F_{2y+1}SO₂)(1≤x≤20, 1≤y≤20), LiCl, LiI, LiSCN, LiB(C₂O₄)₂, LiB(C₃O₄F)₂, LiF₂BC₂O₄, LiPO₂F₂, LiP(C₂O₄)₃, LiPF₄(C₂O₄), LiPF₂(C₂O₄)₂, LiNO₃, LiP(C₂O₄)₃, or a mixture thereof.

The concentration of the lithium salt may be, for example, about 0.01 M to about 10 M, about 0.1 M to about 5 M, or about 0.5 M to about 2 M.

As described above, the lithium salt may be included in a higher content in the soft segment among the soft segment and hard segment of the supramolecular polymer.

A flame retardant or non-flammable polymer gel electrolyte includes a carbonate-based solvent.

The carbonate-based solvent may include, for example, a cyclic carbonate-based solvent, a linear carbonate-based solvent, or a combination thereof.

The carbonate-based solvent may include, for example, a cyclic carbonate-based solvent. The cyclic carbonate-based solvent may include, for example, a fluorine-containing cyclic carbonate-based solvent, a fluorine-free cyclic carbonate-based solvent, or a combination thereof.

The cyclic carbonate-based solvent may include, for example, a compound represented by Formula 13 below:

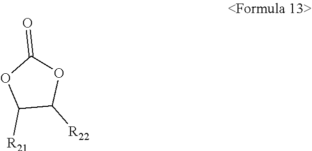

wherein
R₂₁ and R₂₂ are each independently hydrogen, a halogen, or a C1 to C10 alkyl group unsubstituted or substituted with a halogen. In the compound of Formula 13, the halogen may be, for example, fluorine (F).

The cyclic carbonate-based solvent may include, for example, ethylene carbonate (EC), propylene carbonate (PC), fluoroethylene carbonate (FEC), 4,4-difluoroethylene carbonate, 4,5-difluoroethylene carbonate, 4-methyl-5-fluoroethylene carbonate, 4-methyl-5,5-difluoroethylene carbonate, 4-(fluoromethyl)ethylene carbonate, 4-(difluoromethyl)ethylene carbonate, 4-(trifluoromethyl)ethylene carbonate, 4-(2-fluoroethyl)ethylene carbonate, 4-(2,2-difluoroethyl)ethylene carbonate, and 4-(2,2,2-trifluoroethyl)ethylene carbonate, 4,5-dimethylethylene carbonate, or a combination thereof.

The carbonate-based solvent may include, for example, a linear carbonate-based solvent. The linear carbonate-based solvent may include, for example, a fluorine-containing linear carbonate-based solvent, a fluorine-free linear carbonate-based solvent, or a combination thereof.

The linear cyclic carbonate-based solvent may include, for example, a compound represented by Formula 14 below:

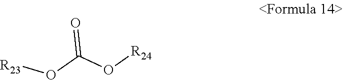

wherein R₂₃ and R₂₄ are each independently hydrogen, a halogen, or a C1 to C10 alkyl group unsubstituted or substituted with a halogen. In the compound represented by Formula 14, the halogen may be, for example, fluorine (F).

The linear carbonate-based solvent may include, for example, dimethyl carbonate, diethyl carbonate, methyl ethyl carbonate, methyl propyl carbonate, ethyl propyl carbonate, methyl isopropyl carbonate, dipropyl carbonate, dibutyl carbonate, or a combination thereof.

The flame-retardant or non-flammable polymer gel electrolyte includes a fluorine-containing linear ester-based solvent.

The fluorine-containing linear ester-based solvent may be represented, for example, by Formula 15 below:

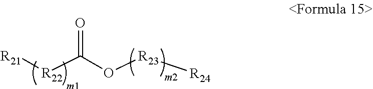

wherein
R₂₁ and R₂₄ are each independently a C1 to C5 alkyl group unsubstituted or substituted with a halogen,
R₂₂ and R₂₃ are each independently a C1 to C5 alkylene group unsubstituted or substituted with a halogen,
At least one of R₂₁, R₂₂, R₂₃ and R₂₄ includes fluorine, and
m1 and m2 are each independently an integer of 0 to 5.

The fluorine-containing linear ester-based solvent may include, for example, fluoromethyl acetate, difluoromethyl acetate, trifluoromethyl acetate, 2-fluoroethyl acetate, 2,2-difluoroethyl acetate, 2,2,2-trifluoroethyl acetate (TFEA), 2,2,2-trifluoroethyl trifluoroacetate (TFEFA), fluoromethyl propionate, difluoromethyl propionate, trifluoromethyl propionate, 2-fluoroethyl propionate, 2,2-difluoroethyl propionate, 2,2,2-trifluoroethyl propionate (TFEP), 2-fluoroethyl butyrate, 2,2-difluoroethyl butyrate, 2,2,2-trifluoroethyl butyrate (TFEB), or a combination thereof.

The flame-retardant or non-flammable polymer gel electrolyte includes a carbonate-based solvent and a fluorine-containing linear ester-based solvent, and the mixing volume ratio of the carbonate-based solvent and the fluorine-containing linear ester-based solvent may be, for example, about 10:90 to about 95:5, about 10:90 to about 80:20, about 10:90 to about 50:50, about 10:90 to about 40:60, or about 20:80 to about 40:60. Since the carbonate-based solvent and the fluorine-containing linear ester-based solvent has a mixing volume ratio in this range, the charge/discharge characteristics of a lithium battery including the flame-retardant or non-flammable polymer gel electrolyte can be improved When the content of the fluorine-containing linear ester-based solvent exceeds 85 vol %, the fluorine-containing linear ester-based solvent and the carbonate-based solvent may not be miscible with each other.

The flame-retardant or non-flammable polymer gel electrolytes may further include an additive.

Examples of the additive may include, but are not limited to, vinylene carbonate (VC), fluoroethylene carbonate (FEC), hexafluoroglutaric anhydride (HFA), pentafluoropropionic anhydride (PFPA), vinylene ethylene carbonate (VEC), pentaerythritol disulfate (PEDS), propane sultone (PS), ethylene sulfate (ES), LiNO₃, compounds represented Formulae 16 to 23 below, and combinations thereof.

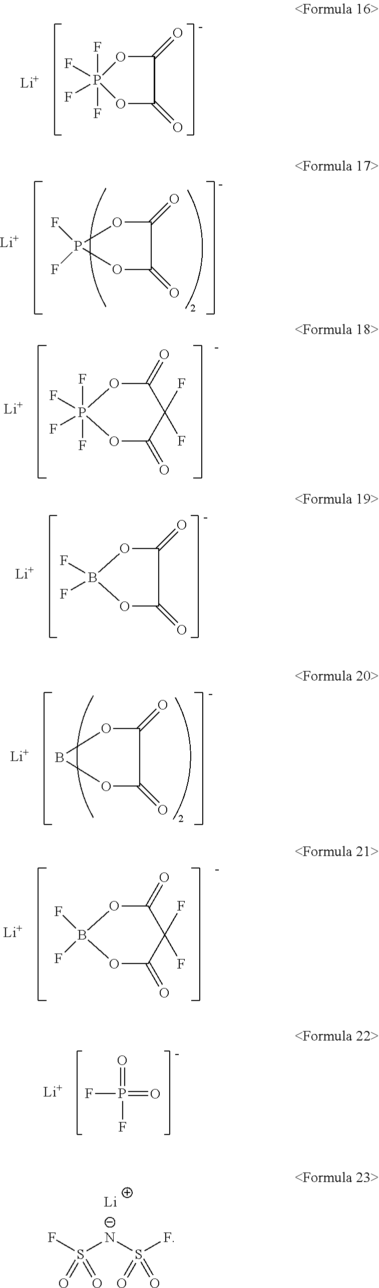

The additive may include one compound or two or more compounds.

The content of the additive may be about 0.01 wt % to about 10 wt %, about 0.1 wt % to about 8 wt %, about 0.1 wt % to about 5 wt %, or about 0.1 wt % to about 3 wt % based on the total weight of the polymer gel electrolyte.

Since the flame-retardant or non-flammable polymer gel electrolyte has an additive content in this range, the charge/discharge characteristics of a lithium battery including the polymer gel electrolyte can be improved.

The self-extinguishing time of the flame-retardant or non-flammable polymer gel electrolyte may be less than 20 sec/g, less than 10 sec/g, or less than 6 sec/g.

Since the flame-retardant or non-flammable polymer gel electrolyte has a self-extinguishing time in this range, the ignition possibility of the flame-retardant or non-flammable polymer gel electrolyte may be suppressed. The flame-retardant or non-flammable polymer gel electrolyte is substantially flame-retardant or non-flammable. The flame-retardant or non-flammable polymer gel electrolyte having a self-extinguishing time of 0 sec/g is a flame retardant or non-flammable polymer gel electrolyte that does not ignite by a torch.

The viscosity of the flame-retardant or non-flammable polymer gel electrolyte may be, for example, about 10 cP to about 1000 cP, about 10 cP to about 500 cP, about 10 cP to about 200 cP, about 10 cP to about 100 cP, about 10 cP to about 50 cP, or about 10 cP to about 30 cP.

Since the flame-retardant or non-flammable polymer gel electrolyte has a viscosity in this range, the polymer gel electrolyte can be easily impregnated into the positive electrode, and thus easily applied onto the surface of a cathode active material. Since the polymer gel electrolyte has a viscosity in this range, side reactions with a lithium metal anode can be suppressed, and a uniform protective film can be formed on the lithium metal anode. Since the flame-retardant or non-flammable polymer gel electrolyte has a viscosity in this range, the charge/discharge characteristics of a lithium battery including the polymer gel electrolyte can be improved.

The ionic conductivity of the flame-retardant or non-flammable polymer gel electrolyte may be 0.1 mS/cm or more, 0.5 mS/cm or more, 1 mS/cm or more, 2 mS/cm or more, 3 mS/cm or more, 4 mS/cm or more, or 5 mS/cm or more at a temperature ranging from −30° C. to 45° C. and at a pressure of 1 atm.

The ionic conductivity of the flame retardant or non-flammable polymer gel electrolyte may be about 0.1 mS/cm to about 100 mS/cm, about 0.5 mS/cm to about 50 mS/cm, about 1 mS/cm to about 20 mS/cm, about 2 mS/cm to about 10 mS/cm, about 3 mS/cm to about 10 mS/cm, about 4 mS/cm to about 10 mS/cm, or about 5 mS/cm to about 10 mS/cm at a temperature ranging from −30° C. to 45° C. and at a pressure of 1 atm. Since the flame-retardant or non-flammable polymer gel electrolyte has an ionic conductivity in this range, the charge/discharge characteristics of a lithium battery including the polymer gel electrolyte can be improved. The ionic conductivity of the flame-retardant or non-flammable polymer gel electrolyte may be measured, for example, by electrochemical impedance spectroscopy (EIS).

### [Lithium Battery]

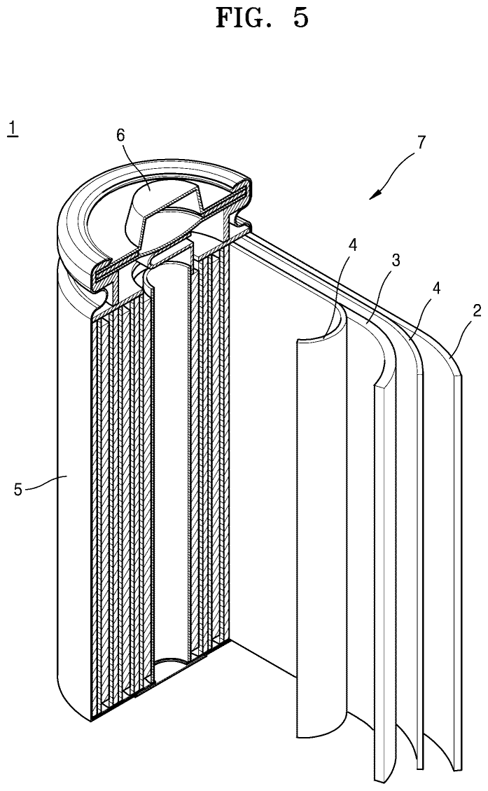

FIGS. 5 to 8 are schematic views of a lithium battery according to an embodiment.

Referring to FIGS. 5 to 8, a lithium battery 1 according to an embodiment includes: a cathode 3; an anode 2; and an electrolyte layer 4 disposed between the cathode 3 and the anode 2, wherein the electrolyte layer 4 includes the above-described polymer gel electrolyte. Since the lithium battery includes the flame-retardant or non-flammable polymer gel electrolyte, the charge/discharge characteristics of the lithium battery can be improved, and the ignition possibility of the lithium battery can be suppressed.

### [Electrolyte Layer: Polymer Gel Electrolyte]

The electrolyte layer 4 includes a flame-retardant or non-flammable polymer gel electrolyte. For the flame retardant or non-flammable polymer gel electrolytes, refer to the above description.

### [Electrolyte Layer: Porous Film]

The electrolyte layer 4 may further include a porous substrate in addition to the flame-retardant or non-flammable polymer gel electrolyte.

The porous substrate may be, for example, a porous film. The porous film may be, for example, a microporous film. The porous film may be, for example, a woven or nonwoven fabric. Any porous film commonly used in lithium batteries may be used. The porous film may include, for example, a glass fiber, an olefin resin, a fluorine resin, an ester resin, an imide resin, an acrylic resin, a cellulose resin, or a combination thereof. The olefin resin may include, for example, polyethylene, polypropylene, or a combination thereof. The fluororesin may include, for example, polyvinylidene fluoride (PVDF), polytetrafluoroethylene (PTFE), or a combination thereof. The ester resin may include, for example, polyethylene terephthalate, polybutylene terephthalate, or a combination thereof. The imide resin may include, for example, polyamideimide, polyetherimide, or a combination thereof. The acrylic resin may include, for example, polyacrylonitrile, polyacrylate, or a combination thereof. The cellulosic resin may include, for example, carboxymethyl cellulose, microbial cellulose, plant cellulose, animal cellulose, or a combination thereof.

The porous substrate may be impregnated with a flame-retardant or non-flammable polymer gel electrolyte. The flame-retardant or non-flammable polymer gel electrolyte may be injected into the porous substrate to prepare a flame-retardant or non-flammable polymer gel electrolyte impregnated in the porous substrate. In particular, the flame retardant or non-flammable polymer gel electrolyte may not need a separate cross-linking process after being impregnated into the porous substrate. As the porous substrate, for example, a porous film having excellent impregnation ability for the flame retardant or non-flammable polymer gel electrolyte may be used. The porous substrate may be, for example, a separator 4.

The porous substrate is manufactured by the following exemplary method, but the disclosure is not necessarily limited thereto, and this method may be adjusted according to required conditions.

First, a polymer resin, a filler, and a solvent are mixed to prepare a composition for forming a porous film. A porous film may be formed by directly applying and drying the composition for forming a porous film onto an electrode. Alternatively, the porous film may be formed by casting the composition for forming a porous film on a support, drying the composition, separating the dried composition from the support and then laminating the composition onto an electrode. The polymer used in forming the porous film is not particularly limited, and the above-described resins may be used. Any polymer used in forming the porous film may be used as a binder for the electrode. The polymer used in forming the porous film may include, for example, vinylidene fluoride/hexafluoropropylene copolymer, polyvinylidene fluoride (PVDF), polyacrylonitrile, polymethyl methacrylate, or a combination thereof.

### [Anode]

The lithium battery 1 includes an anode 2, and the anode 2 includes an anode current collector and an anode active material layer disposed on one side of the anode current collector.

The anode is manufactured by, for example, the following exemplary method, but the disclosure is not necessarily limited thereto, and the method is adjusted according to the required conditions.

First, an anode active material, a conducting agent, a binder, and a solvent are mixed to prepare an anode active material composition, and an anode current collector is directly coated with the composition, and the composition is dried to prepare an anode plate. Alternatively, the prepared anode active material composition is cast on a support and separated from the support to form an anode active material film, and then the anode active material film is laminated onto a copper current collector to manufacture an anode plate.

Any anode active material capable of being used as an anode active material for lithium batteries in the relevant technical field may be used. For example, the anode active material includes at least one selected from a lithium metal, a metal alloyable with lithium, a lithium alloy, silicon (Si), a silicon alloy (silicide; SiₓM_{y}), tin (Sn), a tin alloy (SnₓM_{y}), a transition metal oxide, a non-transition metal oxide, and a carbon-based material.

Examples of the lithium alloy may include, but are not limited to, a Li—Al alloy, a Li—Sn alloy, a Li—In alloy, a Li—Ag alloy, a Li—Au alloy, a Li—Zn alloy, a Li—Ge alloy, and a Li—Si alloy. Any lithium alloy used in the relevant technical field may be used. The anode active material layer may be made of one of these alloys or of lithium, or may be a lithium-containing metal layer or a lithium metal layer made of several types of alloys.

The metal alloyable with lithium include, for example, Si, Sn, Al, Ge, Pb, Bi, Sb Si—Y alloy (wherein Y is an alkali metal, an alkaline earth metal, a group 13 element, a group 14 element, a transition metal, a rare earth element or a combination thereof, but not Si), Sn—Y alloy (wherein Y is an alkali metal, an alkaline earth metal, a group 13 element, a group 14 element, a transition metal, a rare earth element or a combination thereof, but not Sn), etc. The element Y is, for example, Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, Ti, Ge, P, As, Sb, Bi, S, Se, Te, Po, or a combination thereof.

The transition metal oxide includes, for example, lithium titanium oxide, vanadium oxide, lithium vanadium oxide, etc.

The non-transition metal oxide includes, for example, SnO₂, SiOₓ (0<x<2).

The carbon-based material includes, for example, crystalline carbon, amorphous carbon, or a mixture thereof. The crystalline carbon includes graphite, such as natural graphite or artificial graphite, which is amorphous, plate-like, flake-like, spherical or fibrous. The amorphous carbon includes, for example, soft carbon (low-temperature calcined carbon), hard carbon, mesophase pitch carbide, calcined coke, carbon nanotubes, carbon nanowires, and carbon nanorods.

The silicon-graphite composite is a mixture of a graphite-based carbon material and a silicon-based material such as Si, SiOₓ (0<x<2).

The contents of the anode active material, conducting agent, binder and solvent are at levels typically used in lithium batteries. Depending on the purpose and configuration of a lithium battery, one or more of the conducting agent, binder, and solvent may be omitted.

The thickness of the anode active material layer is, for example, about 1 μm to about 200 μm, about 1 μm to about 150 μm, about 1 μm to about 100 μm, about 1 μm to about 50 μm, about 1 μm to about 30 μm, about 1 μm to about 22 μm, or about 1 μm to about 10 μm, but is not limited to these ranges.

The anode current collector includes, for example, a metal substrate. The metal substrate may include, for example, copper (Cu), nickel (Ni), stainless steel (SUS), iron (Fe), and cobalt (Co). The metal substrate may be composed of, for example, one of the above-described metals, or an alloy of two or more metals. The metal substrate is, for example, in the form of a sheet or foil. The thickness of the anode current collector is, for example, about 5 μm to about 50 μm, about 10 μm to about 50 μm, about 10 μm to about 40 μm, or about 10 μm to about 30 μm, but is not limited to these ranges.

### [Cathode]

The lithium battery 1 includes a cathode 3, and the cathode 3 includes a cathode current collector and a cathode active material layer disposed on one side of the cathode current collector.

The cathode is manufactured by, for example, the following exemplary method, but the disclosure is not necessarily limited thereto, and the method is adjusted according to the required conditions.

First, a cathode active material, a conducting agent, a binder, and a solvent are mixed to prepare a cathode active material composition. Then, an aluminum current collector is directly coated with the prepared cathode active material composition, and the composition is dried to prepare a cathode plate. Alternatively, the cathode active material composition is cast on a support and then separated from the support to obtain a film, and the film is laminated on the aluminum current collector to manufacture a cathode plate on which a cathode active material layer is formed.

As the conducting agent, carbon black, graphite particles, natural graphite, artificial graphite, acetylene black, Ketjen black, carbon fibers; carbon nanotubes; metal powders or metal fibers or metal tubes such as copper, nickel, aluminum, and silver; and conductive polymers such as polyphenylene derivatives are used, but the disclosure is not limited thereto. Any conducting agent used in the relevant technical field may be used.

As the binder, vinylidene fluoride/hexafluoropropylene copolymer, polyvinylidene fluoride, polyacrylonitrile, polymethyl methacrylate, polytetrafluoroethylene (PTFE), mixtures of the above polymers, styrene butadiene rubber polymers, and polyacrylic acid are used. As the binder, N-methylpyrrolidone (NMP), acetone, and water are used. However, the disclosure is not necessarily limited thereto, and any binder and any solvent used the relevant technical field may be used.

It is also possible to form pores inside the electrode plate by adding a plasticizer or a pore forming agent to the cathode active material composition.

The contents of the cathode active material, conducting agent, binder, and solvent used in the cathode are at levels typically used in lithium batteries. Depending on the purpose and configuration of a lithium battery, one or more of the conducting agent, binder, and solvent may be omitted.

The cathode active material layer includes a cathode active material. The cathode active material may be any material used in the relevant technical field, for example, a lithium-containing metal oxide. The cathode active material may be, for example, at least one of a composite oxide of lithium and a metal selected from cobalt, manganese, nickel, and combinations thereof. Specifically, the cathode active material may be a compound represented by any one of Formulae: LiₐA_{1-b}B′_{b}D₂ (wherein 0.90≤a≤1, and 0≤b≤0.5); LiₐE_{1-b}B′_{b}O_{2-c}D_{c} (wherein 0.90≤a≤1, 0≤b≤0.5, 0≤c≤0.05); LiE_{2-b}B′_{b}O_{4-c}D_{c} (wherein 0≤b≤0.5, 0≤c≤0.05); LiₐNi_{1-b-c}Co_{b}B′_{c}D_{α} (wherein 0.90≤a≤1, 0≤b≤0.5, 0≤c≤0.05, 0<α≤2); LiₐNi_{1-b-c}Co_{b}B′_{c}O_{2-α}F′_{α} (wherein 0.90≤a≤1, 0≤b≤0.5, 0≤c≤0.05, 0<α<2); LiₐNi_{1-b-c}Co_{b}B′_{c}O_{2-α}F′_{α} (wherein 0.90≤a≤1, 0≤b≤0.5, 0≤c≤0.05, 0<α<2); LiₐNi_{1-b-c}Mn_{b}B′_{c}D_{α} (wherein 0.90≤a≤1, 0≤b≤0.5, 0≤c≤0.05, 0<α≤2); LiₐNi_{1-b-c}Mn_{b}B′_{c}O_{2-α}F′_{α} (wherein, 0.90≤a≤1, 0≤b≤0.5, 0≤c≤0.05, 0<α<2); LiₐNi_{1-b-c}Mn_{b}B′_{c}O_{2-α}F′_{α} (wherein 0.90≤a≤1, 0≤b≤0.5, 0≤c≤0.05, 0<α<2); LiₐNi_{b}E_{c}G_{d}O₂ (wherein 0.90≤a≤1, 0≤b≤0.9, 0≤c≤0.5, 0.001≤d≤0.1); LiₐNi_{b}Co_{c}Mn_{d}GₑO₂ (wherein 0.90≤a≤1, 0≤b≤0.9, 0≤c≤0.5, 0≤d≤0.5, 0.001≤e≤0.1); LiₐNiG_{b}O₂ (wherein 0.90≤a≤1, 0.001≤b≤0.1); LiₐCoG_{b}O₂ (wherein 0.90≤a≤1, 0.001≤b≤0.1); LiₐMnG_{b}O₂ (wherein 0.90≤a≤1, 0.001≤b≤0.1); LiₐMn₂G_{b}O₄ (wherein 0.90≤a≤1, 0.001≤b≤0.1); QO₂, QS₂; LiQS₂; V₂O₅; LiV₂O₅; LiI′O₂; LiNiVO₄; Li_{(3-f)}J₂(PO₄)₃ (0≤f≤2); Li_{(3-f)}Fe₂(PO₄)₃ (0≤f≤2); LiFePO₄; and LiFe_{(1-f)}HfPO₄ (wherein 0.01≤f<1).

In the formulae representing the above-described compounds, A is Ni, Co, Mn, or a combination thereof; B′ is Al, Ni, Co, Mn, Cr, Fe, Mg, Sr, V, a rare earth element, or a combination thereof; D is O, F, S, P, or a combination thereof; E is Co, Mn, or a combination thereof; F′ is F, S, P, or a combination thereof; G is Al, Cr, Mn, Fe, Mg, La, Ce, Sr, V, or a combination thereof; H is Ni, Co, Mn, or a combination thereof; Q is Ti, Mo, Mn, or a combination thereof; I′ is Cr, V, Fe, Sc, Y, or a combination thereof; and J is V, Cr, Mn, Co, Ni, Cu, or a combination thereof. It is also possible to use a compound having a coating layer added to the surface of the above-described compound, and it is also possible to use a mixture of the above-described compound and a compound having a coating layer added to the surface thereof. The coating layer added to the surface of the above-described compound includes a coating element compound, for example, an oxide of the coating element, a fluoride of the coating element, a hydroxide of the coating element, an oxyhydroxide of the coating element, an oxycarbonate of the coating element, or a hydroxycarbonate of the coating element. The compound forming this coating layers is amorphous or crystalline. The coating element included in the coating layer includes Mg, Al, Co, K, Na, Ca, Si, Ti, V, Sn, Ge, Ga, B, As, Zr, Nb, or a mixture thereof. The method of forming the coating layer is selected within a range that does not adversely affect the properties of the cathode active material. Coating methods include spray coating, dipping, etc. Since the specific coating method is well understood by those skilled in the art, a detailed description will be omitted.

The cathode active material may include, for example, lithium transition metal oxides represented by Formulae 24 to 31:

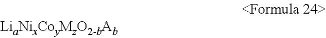

wherein
1.0≤a≤1.2, 0≤b≤0.2, 0.8≤x<1, 0≤y≤0.3, 0<z≤0.3, and x+y+z=1,
M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and
A is F, S, Cl, Br or a combination of thereof;

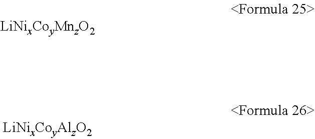

in Formulae 25 to 26, 0.8≤x≤0.95, 0≤y≤0.2, 0<z≤0.2, and x+y+z=1;

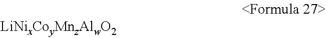

wherein 27, 0.8≤x≤0.95, 0≤y≤0.2, 0<z≤0.2, 0<w≤0.2, and x+y+z+w=1;

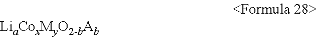

wherein
1.0≤a≤1.2, 0≤b≤0.2, 0.9≤x≤1, 0≤y≤0.1, and x+y=1,
M is manganese (Mn), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and
A is F, S, Cl, Br or a combination thereof;

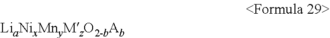

wherein
1.0≤a≤1.2, 0≤b≤0.2, 0<x≤0.3, 0.5≤y<1, 0<z≤0.3, and x+y+z=1,
M′ is cobalt (Co), niobium (Nb), vanadium (V), magnesium (Mg), gallium (Ga), silicon (Si), tungsten (W), molybdenum (Mo), iron (Fe), chromium (Cr), copper (Cu), zinc (Zn), titanium (Ti), aluminum (Al), boron (B), or a combination thereof, and
A is F, S, Cl, Br or a combination thereof,

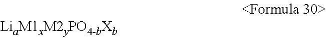

wherein, in Formula 30, 0.90≤a≤1.1, 0≤x≤0.9, 0≤y≤0.5, 0.9<x+y<1.1, 0≤b≤2,
M1 is chromium (Cr), manganese (Mn), iron (Fe), cobalt (Co), nickel (Ni), copper (Cu), zirconium (Zr), or a combination thereof, and
M2 is magnesium (Mg), calcium (Ca), strontium (Sr), barium (Ba), titanium (Ti), zinc (Zn), boron (B), niobium (Nb), gallium (Ga), indium (In), molybdenum (Mo), tungsten (W), aluminum (Al), silicon (Si), chromium (Cr), vanadium (V), scandium (Sc), yttrium (Y) or a combination thereof, and X is O, F, S, P or a combination thereof; and

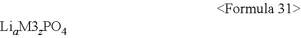

wherein, in Formula 31, 0.90≤a≤1.1, 0.9≤z≤1.1, and
M3 is chromium (Cr), manganese (Mn), iron (Fe), cobalt (Co), nickel (Ni), copper (Cu), zirconium (Zr), or a combination thereof.

The thickness of the cathode active material layer is, for example, about 1 μm to about 200 μm, about 1 μm to about 150 μm, about 1 μm to about 100 μm, about 1 μm to about 50 μm, about 1 μm to about 30 μm, about 1 μm to about 22 μm, or about 1 μm to about 10 μm, but is not limited to these ranges.

The cathode current collector includes, for example, a metal substrate. The metal substrate may be made of, for example, aluminum (Al), indium (In), copper (Cu), magnesium (Mg), stainless steel, titanium (Ti), iron (Fe), cobalt (Co), nickel (Ni), zinc (Zn), germanium (Ge) or an alloy thereof. The metal substrate may be composed of, for example, one of the above-described metals, or an alloy of two or more metals. The metal substrate is, for example, in the form of a sheet or foil. The thickness of the cathode current collector is, for example, about 5 μm to about 50 μm, about 10 μm to about 50 μm, about 10 μm to about 40 μm, or about 10 μm to about 30 μm, but is not limited to these ranges.

The lithium battery 1 may have a structure as shown in FIGS. 5 to 8 below.

Referring to FIG. 5, a lithium battery 1 according to an embodiment includes a cathode 3, the above-described anode 2, and a separator 4. The cathode 3, the anode 2, and separator 4 are wound or folded to form a battery structure 7. The formed battery structure 7 is accommodated in a battery case 5. A flame retardant or non-flammable polymer gel electrolyte is injected into the battery case and sealed with a cap assembly 6, thereby completing the lithium battery 1. The battery case 5 is cylindrical, but is not necessarily limited to this shape, and may be, for example, rectangular thin-film-shaped, or the like.

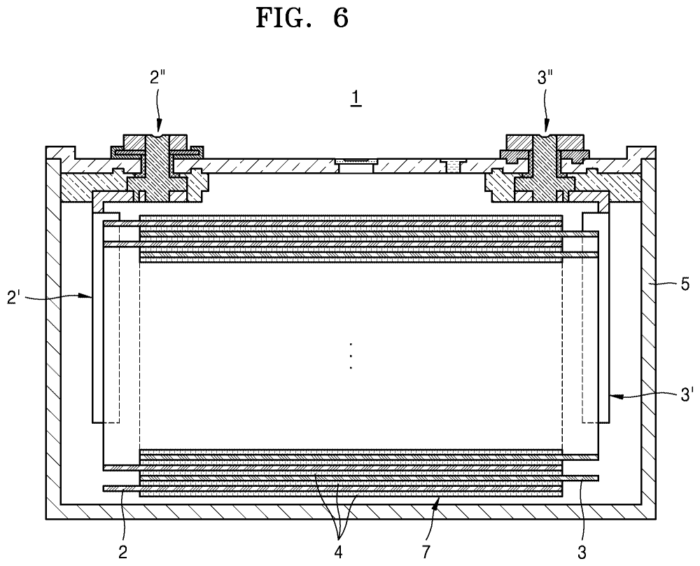

Referring to FIG. 6, a lithium battery 1 according to an embodiment includes a cathode 3, the above-described anode 2, and a separator 4. The cathode 3, the anode 2, and separator 4 are wound, folded or stacked to form a battery structure 7. The formed battery structure 7 is accommodated in a battery case 5. A flame retardant or non-flammable polymer gel electrolyte is injected into the battery case 5 and sealed to complete the lithium battery 1. The battery case 5 is rectangular, but is not necessarily limited to this shape, and may be, for example, cylindrical, thin-film-shaped, or the like. A cathode lead tab 3′ and a cathode terminal 3″ are electrically connected to the cathode 3. An anode lead tab 2′ and an anode terminal 2″ are electrically connected to the anode 2.

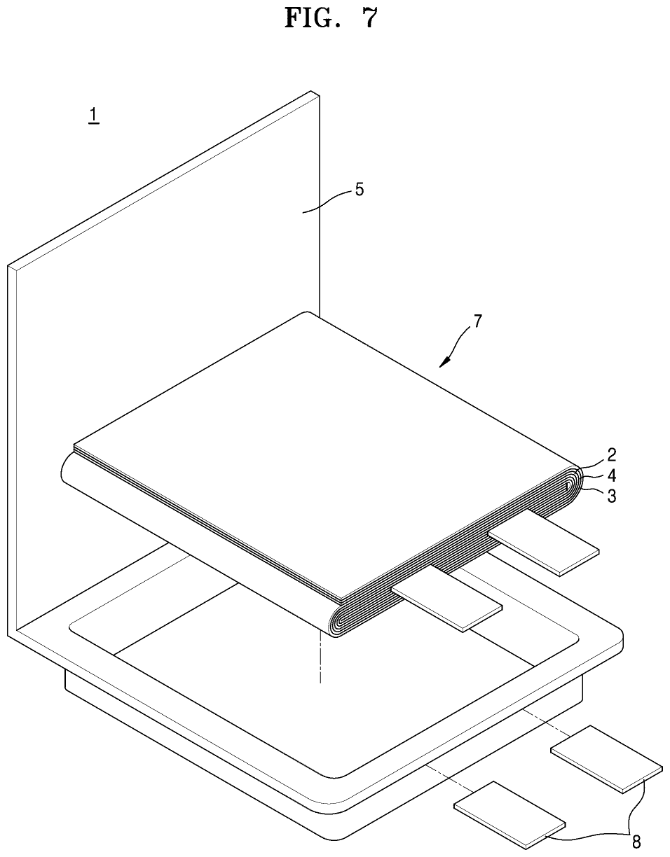

Referring to FIG. 7, a lithium battery 1 according to an embodiment includes a cathode 3, the above-described anode 2, and a separator 4. The separator 4 is placed between the cathode 3 and the anode 2, and the cathode 3, the anode 2, and the separator 4 are wound or folded to form a battery structure 7. The formed battery structure 7 is accommodated in the battery case 5. The lithium battery 1 may include electrode tabs 8 serving as an electrical path for inducing the current formed in the battery structure 7 to the outside. A flame retardant or non-flammable polymer gel electrolyte is injected into the battery case 5 and sealed to complete the lithium battery 1. The battery case 5 is rectangular, but is not necessarily limited to this shape, and may be, for example, cylindrical, thin-film-shaped, pouch-shaped, or the like.

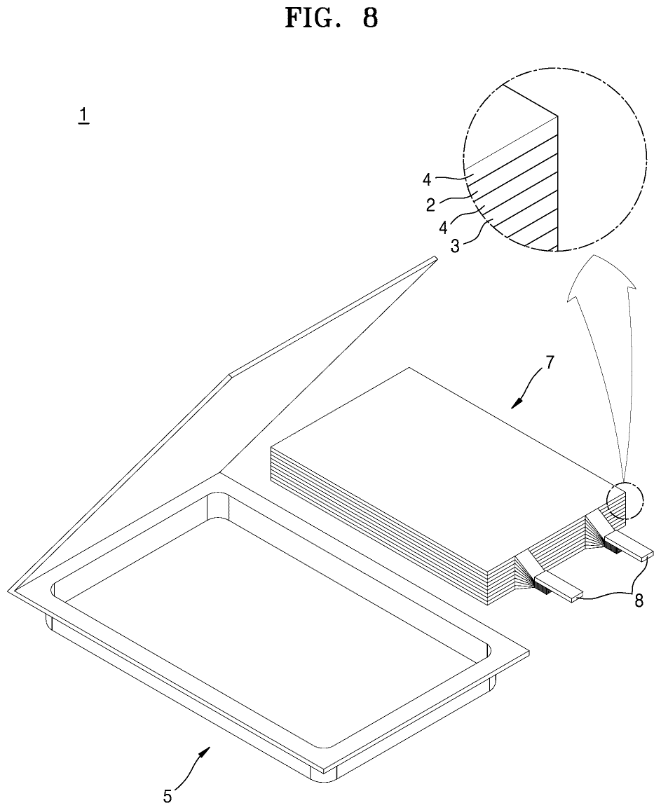

Referring to FIG. 8, a lithium battery 1 according to an embodiment includes a cathode 3, the above-described anode 2, and a separator 4. The separator 4 is placed between the cathode 3 and the anode 2 to form a battery structure 7. The battery structure 7 is stacked in a bi-cell structure and then accommodated in a battery case 5. The lithium battery 1 may include electrode tabs 8 serving as an electrical path for inducing the current formed in the battery structure 7 to the outside. A flame retardant or non-flammable polymer gel electrolyte is injected into the battery case 5 and sealed to complete the lithium battery 1. The battery case 5 is rectangular, but is not necessarily limited to this shape, and may be, for example, cylindrical, thin-film-shaped, pouch-shaped, or the like.

A pouch-type lithium metal battery or lithium ion battery uses a pouch as a case for the lithium battery of FIGS. 5 to 8. A pouch-type lithium battery may include one or more battery structures. A separator is placed between a cathode and an anode to form a battery structure. A plurality of battery structures are laminated in a thickness direction, impregnated with a flame-retardant or non-flammable polymer gel electrolyte, and placed and sealed in a pouch to complete a pouch-type battery. For example, although not shown in the drawings, the above-described cathode, anode, and separator may be simply laminated and accommodated in a pouch in the form of an electrode assembly, or may be wound or folded into a jellyroll-shaped electrode assembly and then accommodated in a pouch. Then, a composition for forming a cathode electrolyte is injected into the pouch, and thermal cross-linking and sealing are performed to complete the lithium battery.

The lithium battery of the present disclosure has excellent lifespan characteristics and high energy density, and is therefore used in, for example, electric vehicles (EVs). For example, this lithium battery is used in hybrid vehicles such as plug-in hybrid electric vehicles (PHEVs). Further, this lithium battery is also used in fields that require large amounts of power storage. For example, this lithium battery is used in electric bicycles, power tools, urban air mobility (UAM), and energy storage systems (ESSs).

A plurality of lithium batteries are stacked to form a battery module, and the plurality of battery modules forms a battery pack. Such a battery pack may be used in any device that requires high capacity and high output. For example, this battery pack may be used in laptops, smartphones, electric vehicles, etc. A battery module includes, for example, a plurality of batteries and a frame that holds them. A battery pack includes, for example, a plurality of battery modules and a bus bar connecting them. The battery module and/or battery pack may further include a cooler. Multiple battery packs are controlled by a battery management system. The battery management system includes a battery pack and a battery control device connected to the battery pack.

### [Method of Preparing Supramolecular Polymer]

A method of preparing a supramolecular polymer according to an embodiment includes: reacting a first precursor compound including a soft segment, a first solution including a first solvent, and a second precursor compound including a hard segment to prepare a prepolymer; and reacting a third precursor compound including a spacer, a second solution including a second solvent, and the prepolymer to prepare a supramolecular polymer, wherein the first solvent and the second solvent have a first volume ratio in which 70 parts by volume or less of the second solvent is included with respect to 100 parts by volume of the first solvent, or a second volume ratio in which 80 parts by volume or more of the second solvent is included with respect to 100 parts by volume of the first solvent, and viscosity of a first supramolecular polymer prepared by the first volume ratio is 50% or less of viscosity of a second supramolecular polymer prepared by the second volume ratio.

In the method of preparing a supramolecular polymer, the type and/or strength of reversible non-covalent bonds included in the supramolecular polymer may differ depending on the volume ratio of the first solvent and the second solvent. Thus, supramolecular polymers including repeating units of the same structure but having different physical properties, such as viscosity and elastic modulus, may be prepared.

First, a first precursor compound including a soft segment, a first solution including a first solvent, and a second precursor compound including a hard segment are reacted to prepare a prepolymer.

The first precursor compound comprising a soft segment may include, for example, a copolymer including an alkylene oxide repeating unit.

The first precursor compound may include, for example, a polymer including an ethylene oxide repeating unit, a copolymer including an ethylene oxide repeating unit and a propylene oxide repeating unit, or a copolymer including an ethylene oxide repeating unit, a propylene oxide repeating unit, and an ethylene oxide repeating unit. The copolymer including an alkylene oxide repeating unit may be, for example, a random copolymer or a block copolymer.

The first precursor compound may include, for example, poly(ethylene oxide), poly(propylene oxide), poly(ethylene glycol)-b-(polypropylene glycol), poly(ethylene glycol)-b-(polypropylene glycol)-b-(polyethylene glycol), poly(ethylene glycol)diglycidyl ether, or a combination thereof.

The first precursor compound may include, for example, HO(CH₂CH₂O)ₘ₁H (m1 is 2 to 500), HO(CH₂CH₂O)ₘ₂(CH₂CH(CH₃)O)ₘ₃H (m2 and m3 are each 2 to 300), or HO(CH₂CH₂O)ₘ₄(CH₂CH(CH₃)O)ₘ₅(CH₂CH₂O)ₘ₆H (m4, m5, and m6 are each 2 to 300).

The first solvent may be, for example, a polar solvent. The first solvent may be, for example, an aprotic solvent. The first solvent may be any polar and aprotic solvent that can be used in the preparation of polymers. The first solvent may be, for example, dimethylacetamide.

The second precursor compound may be, for example, an isocyanate-based compound including an aromatic ring, an aliphatic ring or a combination thereof. The isocyanate-based compound may include, for example, an isocyanate-based compound having a skeleton of Formulae 3a to 3g. The isocyanate-based compound may include, for example, methylenediphenyl diisocyanate (MDI), isophorone diisocyanate (IPDI), etc.

The prepolymer is prepared by the reaction of the first precursor compound and the second precursor compound. The prepolymer may include a residual reactive functional group, such as an isocyanate group. Therefore, the prepolymer can additionally react with the spacer to be described below.

The molecular weight of the prepolymer may range, for example, from about 5% to about 90% of the molecular weight of the supramolecular polymer as the final product.

Next, a third precursor compound including a spacer, a second solution including a second solvent, and the prepolymer are reacted to prepare a supramolecular polymer.

The third precursor compound is a compound that provides a spacer that is placed between the hard segments of the prepolymer.

The third precursor compound may be selected from the above-described first precursor compounds.

Alternatively, the third precursor compound may be selected from amine compounds. The third precursor compound may include, for example, diethylene glycol, ethylenediamine, polyethyleneimine, ureidopyrimidinone, and the like. The flexibility of the supramolecular polymer can be further improved by the addition of a spacer. The glass transition temperature of the supramolecular polymer can be further lowered by the addition of a spacer.

The second solvent may be, for example, a polar solvent. The second solvent may be, for example, an aprotic solvent. The second solvent may be any polar and aprotic solvent that can be used in the preparation of polymers. The second solvent may be, for example, dimethylacetamide.

The first solvent and the second solvent may have a first volume ratio including 70 parts by volume or less of the second solvent per 100 parts by volume of the first solvent.

The first volume ratio may be, for example, a ratio of 1 to 70 parts by volume of the second solvent, 1 to 10 to 50 parts by volume of the second solvent, or 20 to 45 parts by volume of the second solvent per 100 parts by volume of the first solvent.

The first solvent and the second solvent have the first volume ratio, and thus the viscosity of the prepared supramolecular polymer can be reduced. A first supramolecular polymer prepared under conditions in which the first solvent and the second solvent have the first volume ratio may have a significantly lower viscosity than a second supramolecular polymer prepared under conditions outside the first volume ratio. That is, the first supramolecular polymer may have a flexible structure and low viscosity by reducing the degree and/or strength of reversible non-covalent bonding of a polymeric array of repeating units and monomer units constituting the first supramolecular polymer. Therefore, the handling of the first supramolecular polymer can be facilitated by having structural stability and low viscosity. A polymer gel electrolyte including the first supramolecular polymer can be prepared more easily. The charge/discharge characteristics of a lithium battery including the first supramolecular polymer can be further improved.

Alternatively, the first solvent and the second solvent may have a second volume ratio including 80 parts by volume or more of the second solvent per 100 parts by volume of the first solvent.

The second volume ratio may be, for example, a ratio of 80 to 500 parts by volume of the second solvent, 80 to 300 parts by volume of the second solvent, or 80 to 150 parts by volume of the second solvent per 100 parts by volume of the first solvent.

The first solvent and the second solvent have the second volume ratio, and thus the viscosity of the prepared supramolecular polymer can be increased. A second supramolecular polymer prepared under conditions in which the first solvent and the second solvent have the second volume ratio may have a significantly lower viscosity than the first supramolecular polymer prepared under conditions of having the first volume ratio. That is, the second supramolecular polymer may have a rigid structure and high viscosity by increasing the degree and/or strength of reversible non-covalent bonding of a polymeric array of repeating units and monomer units constituting the second supramolecular polymer. Therefore, the handling of the second supramolecular polymer may not be facilitated.

The viscosity of the first supramolecular polymer prepared by the first volume ratio may be, for example, 50% or less, 40% or less, 30% or less, 20% or less, or 10% or less of the viscosity of the second supramolecular polymer prepared by the second volume ratio. The viscosity of the first supramolecular polymer prepared by the first volume ratio may be, for example, about 1% to about 50%, about 1% to about 40%, about 1% to about 30%, about 1% to about 20% or about 1% to about 10% of the viscosity of the second supramolecular polymer prepared by the second volume ratio. The viscosity of the first supramolecular polymer and the second supramolecular polymer may be measured by a rheometer under conditions of 25° C., 1 atm, a shear stress (T) of 1 Pa, and a frequency of 1.0 Hz.

As used herein, a substituent is derived by exchanging at least one hydrogen atom with another atom or functional group in an unsubstituted mother group. Unless otherwise stated, when a functional group is considered to be “substituted,” it means that this functional group is substituted with one or more substituents selected from an alkyl group having 1 to 40 carbon atoms, an alkenyl group having 2 to 40 carbon atoms, an alkynyl group having 2 to 40 carbon atoms, a cycloalkyl group having 3 to 40 carbon atoms, a cycloalkenyl group having 3 to 40 carbon atoms, and an aryl group having 7 to 40 carbon atoms. When a functional group is described as being “optionally substituted,” it means that the functional group may be substituted with the above-described substituent.

As used herein, a and b in “carbon number a to b” or “Ca to Cb” or “Ca-Cb” represent the carbon number of a specific functional group. That is, the functional group may include carbon atoms from a to b. For example, “an alkyl group having 1 to 4 carbon atoms” or “C1 to C4” or “C1-C4” means an alkyl group having 1 to 4 carbon atoms, i.e., CH₃—, CH₃CH₂—, CH₃CH₂CH₂—, (CH₃)₂CH—, CH₃CH₂CH₂CH₂—, CH₃CH₂CH(CH₃)—, and (CH₃)₃C—.

The nomenclature for a particular radical may include either a monoradical or a diradical, depending on the context. For example, if a substituent requires two linking points to other molecules, the substituent should be understood as a diradical. For example, the substituent specified as an alkyl group requiring two linking points includes diradicals such as —CH₂—, —CH₂CH₂—, —CH₂CH(CH₃)CH₂—, or the like. Other radical nomenclatures, such as “acylene,” clearly indicate that the radical is a diradical.

As used herein, the term “aliphatic ring” refers to a ring or ring system composed of atoms joined through single bonds. Alternatively, the term “aliphatic ring” refers to a ring or ring system that does not have a conjugated pi electron system. “Aliphatic ring” includes an aliphatic carbon ring (e.g., a cyclohexyl group) and an aliphatic hetero ring (e.g., tetrahydrofuran). An aliphatic hetero ring is a ring that includes one or more heteroatoms such as oxygen, nitrogen, or sulfur in addition to carbon.

As used herein, the term “alkyl group” or “alkylene group” refers to a branched or unbranched aliphatic hydrocarbon group. In an embodiment, the alkyl group may be substituted or unsubstituted. Alkyl groups include, but are not necessarily limited to, a methyl group, an ethyl group, a propyl group, an isopropyl group, a butyl group, an isobutyl group, a tert-butyl group, a pentyl group, a hexyl group, a cyclopropyl group, a cyclopentyl group, a cyclohexyl group, a cycloheptyl group, and the like, each of which may be optionally substituted or unsubstituted. In an embodiment, the alkyl group may have 1 to 6 carbon atoms. For example, alkyl groups having 1 to 6 carbon atoms may be, but are not necessarily limited to, methyl, ethyl, propyl, isopropyl, butyl, iso-butyl, sec-butyl, pentyl, 3-pentyl, hexyl, and the like.

As used herein, the term “alkylene group” refers to an alkyl group requiring two or more linking points. In an embodiment, the alkylene group may have 1 to 6 carbon atoms. For example, alkylene groups having 1 to 6 carbon atoms may be, but are not necessarily limited to, methylene, ethylene, propylene, isopropylene, butylene, isobutylene, propylene, hexylene, and the like.

As used herein, the term “cycloalkylene group” refers to a cycloalkyl group requiring two or more linking points. In an embodiment, the cycloalkylene group may have 5 to 10 carbon atoms. For example, the cycloalkylene group having 5 to 10 carbon atoms may be, but is not necessarily limited to, cyclopentylene, cyclohexylene, cycloheptylene, cyclooctylene, cyclononylene, cyclodecylene, or the like.

As used herein, the term “aromatic” refers to a ring or ring system having a conjugated pi electron system. “Aromatic” includes an aromatic carbon ring (e.g., a phenyl group) and an aromatic hetero ring (e.g., pyridine). The term “aromatic” includes monocyclic rings or a fused polycyclic rings (i.e. rings that share adjacent pairs of atoms) if the entire ring system is aromatic.

As used herein, the term “aryl group” refers to an aromatic ring, a ring system (i.e., two or more fused rings sharing two adjacent carbon atoms), or a ring in which multiple aromatic rings are linked to each other by a single bond, —O—, —S—, —C(═O)—, —S(═O)₂—, —Si(Ra)(Rb)— (Ra and Rb are each independently an alkyl group having 1 to 10 carbon atoms), an alkylene group having 1 to 10 carbon atoms which is unsubstituted or substituted with a halogen, or —C(═O)—NH—. When the aryl group is a ring system, each ring in the system is aromatic. Example of the aryl group include, but are not limited to, a phenyl group, a biphenyl group, a naphthyl group, a phenanthrenyl group, and a naphthacenyl group. The aryl group may be substituted or unsubstituted.

As used herein, the term “arylene group” refers to an aryl group requiring two or more linking points. A tetravalent arylene group is an aryl group that requires four linking points, and a divalent arylene group is an aryl group that requires two linking points. For example, there are —C₆H₅—O—C₆H₅—, and the like.

As used herein, the term “heteroaryl group” refers to an aromatic ring system that has one ring, multiple fused rings, or multiple rings linked to each other by a single bond, —O—, —S—, —C(═O)—, —S(═O)₂—, —Si(Ra)(Rb)— (Ra and Rb are each independently an alkyl group having 1 to 10 carbon atoms), an alkylene group having 1 to 10 carbon atoms which is unsubstituted or substituted with a halogen, or —C(═O)—NH—, wherein at least one ring atom is not carbon, i.e., a heteroatom. In the fused ring system, one or more heteroatoms may be present in only one ring. In the fused ring system, one or more heteroatoms may be present in only one ring. For example, heteroatoms include, but are not necessarily limited to, oxygen, sulfur, and nitrogen. For example, the heteroaryl group may be, but is not limited to, a furanyl group, a thienyl group, an imidazolyl group, a quinazolinyl group, a quinolinyl group, an isoquinolinyl group, a quinoxalinyl group, a pyridinyl group, a pyrrolyl group, an oxazolyl group, an indolyl group, or the like.

As used herein, the term “heteroarylene group” refers to a heteroaryl group requiring two or more linking points. A tetravalent heteroarylene group is a heteroaryl group that requires four linking points, and a divalent heteroarylene group is a heteroaryl group that requires two linking points.

The present creative idea will be described in more detail through the following Examples and Comparative Examples. However, Examples are intended to illustrate the creative idea, and the scope of the creative idea is not limited to these Examples.

### (Preparation of Supramolecular Polymer)

### Preparation Example 1: First Precursor Compound (PEG-PPG-PEG Mn 2000), 15 mL of First Solvent (DMAc), 15 mL of Second Solvent (DMAc)

As a first precursor compound, an ethylene glycol-propylene glycol-ethylene glycol block copolymer (poly(ethylene glycol)-block-poly(propylene glycol)-block-poly(ethylene glycol), Sigma-Aldrich) having a number-average molecular weight (Mn) of about 2000 Dalton was dried in a reactor at 100° C. for 24 hours to remove moisture, and thus a dry first precursor compound, PEG-PPG-PEG copolymer, was prepared.

A first solution containing a second precursor compound, 4,4′-methylenebis(phenylisocyanate), dissolved in 15 ml of a first solvent, dimethylacetamide (DMAc), was mixed with the PEG-PPG-PEG copolymer and reacted with stirring for 24 hours in a nitrogen atmosphere at 80° C. to prepare a prepolymer.

A second solution containing a third precursor compound, poly(propylene glycol) bis(2-aminopropyl ether) (Sigma-Aldrich) having a number average molecular weight of about 2000 Dalton, dissolved in 15 ml of dimethylacetamide (DMAc), a second solvent, was mixed with the prepolymer and reacted with stirring for 48 hours at 80° C. in a nitrogen atmosphere to prepare a polymer product.

The polymer product was dried in an oven at 60° C. for 24 hours to remove moisture, and thus a supramolecular polymer (P-2000) was prepared.

### Preparation Example 2: First Precursor Compound (PEG-PPG-PEG Mn 4400), 15 mL of First Solvent (DMAc), 15 mL of Second Solvent (DMAc)

A supramolecular polymer (P-4400) was prepared in the same manner as in Preparation Example 1, except that an ethylene glycol-propylene glycol-ethylene glycol block copolymer (poly(ethylene glycol)-block-poly(propylene glycol)-block-poly(ethylene glycol), Sigma-Aldrich) having a number-average molecular weight (Mn) of about 4400 Dalton was used as the first precursor compound.

### Preparation Example 3: First Precursor Compound (PEG-PPG-PEG Mn 5800, P-5800), 15 mL of First Solvent (DMAc), 15 mL of Second Solvent (DMAc)

A supramolecular polymer (P-5800) was prepared in the same manner as in Preparation Example 1, except that an ethylene glycol-propylene glycol-ethylene glycol block copolymer (poly(ethylene glycol)-block-poly(propylene glycol)-block-poly(ethylene glycol), Sigma-Aldrich) having a number-average molecular weight (Mn) of about 5800 Dalton was used as the first precursor compound.

### Preparation Example 4: First Precursor Compound (PEG-PPG-PEG Mn 5800, P-5800-SC), 15 mL of First Solvent (DMAc), 5 mL of Second Solvent (DMAc)

A supramolecular polymer (P-5800-SC) was prepared in the same manner as in Preparation Example 3, except that 5 ml of dimethylacetamide was used as a solvent in the preparation of the second solution.

### Preparation Example 5: First Precursor Compound (PEG-PPG-PEG Mn 5800, P-5800-SC NS), 15 mL of First Solvent (DMAc)

As a first precursor compound, an ethylene glycol-propylene glycol-ethylene glycol block copolymer (poly(ethylene glycol)-block-poly(propylene glycol)-block-poly(ethylene glycol), Sigma-Aldrich) having a number-average molecular weight (Mn) of about 5800 Dalton was dried in a reactor at 100° C. for 24 hours to remove moisture, and thus a dry first precursor compound, PEG-PPG-PEG copolymer, was prepared.

A first solution containing a second precursor compound, 4,4′-methylenebis(phenylisocyanate), dissolved in 15 ml of a first solvent, dimethylacetamide (DMAc), was mixed with 7.9 parts by weight of 100 parts by weight of the PEG-PPG-PEG copolymer, and reacted with stirring at 80° C. in a nitrogen atmosphere for 48 hours to prepare a polymer product.

The polymer product was dried in an oven at 60° C. for 24 hours to remove moisture, and thus a supramolecular polymer (P-5800-SC NS) was prepared.

### Evaluation Example 1: Confirmation of Synthesis of Supramolecular Polymers

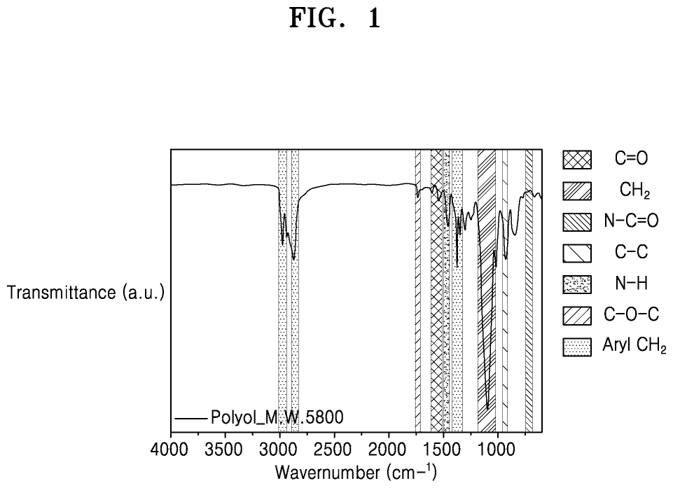

In order to confirm whether the supramolecular polymer prepared in Preparation Example 3 was synthesized, an infrared spectrum was measured, and the results thereof are shown in FIG. 1.

As shown in FIG. 1, it was confirmed that a stretching peak of a C═O urethane bond at 1706 cm-1, a stretching peak of a urea bond at 1640 cm-1, and an N—H stretching peak of a urethane/urea bond at 1548 cm-1 are included.

It was confirmed that a supramolecular polymer including a urethane bond and a urea bond was prepared.

### Evaluation Example 2: Evaluation of Properties of Supramolecular Polymers

The molecular weight, viscosity, glass transition temperature, melting point, and thermal decomposition temperature of the supramolecular polymers prepared in Preparation Examples 1 to 4 were measured using gel permeation chromatography, viscometer, and differential scanning calorimetry.

A rheometer was used as the viscometer, and the measurement conditions were shear stress (T) 1.0 Pa, frequency 1.0 Hz, and temperature 25° C.

The glass transition temperature and melting point were measured using differential scanning calorimetry (DSC). The measurement conditions were a heating rate of 10° C./min and a measurement range of −80° C. to 120° C.

The thermal decomposition temperature was measured by thermogravimetric analysis (TGA). The measurement conditions were a heating rate of 10° C./min and a measurement range of 25° C. to 600° C.

The molecular weights of the supramolecular polymers were measured for polystyrene standard samples using gel permeation chromatography (GPC).

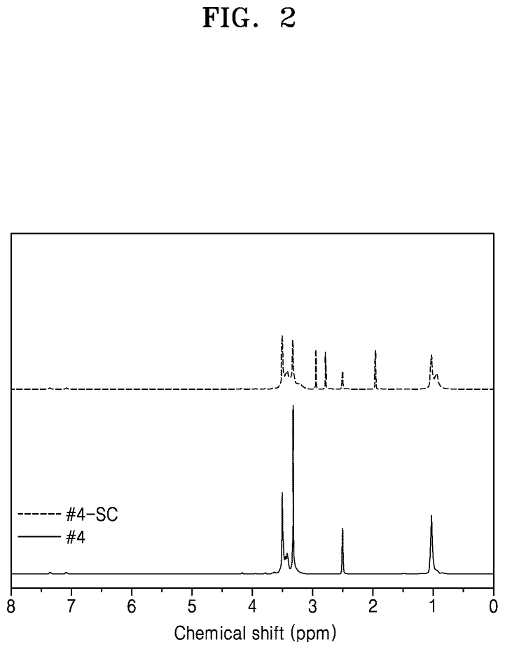

The measurement results are shown in Table 1 below. The NMR measurement results for the supramolecular polymers prepared in Preparation Examples 3 and 4 are shown in FIG. 2.

TABLE 1

| | | | Glass | Melting | Thermal |
|---|---|---|---|---|---|
| | Molecular | | transition | point | decomposition |
| | weight | Viscosity | temperature | (Tm) | temperature |
| Supramolecular polymer | (Mw) | [mP · s] | (Tg) [° C.] | [° C.] | (Td) [° C.] |
| Preparation Example 1 (P-2000) | 32086 | 3341 | −70.1 | — | 288 |
| Preparation Example 2 (P-4400) | 26497 | 45736 | −68.9 | 12.9 | 230 |
| Preparation Example 3 (P-5800) | 24313 | 125581 | −68.1 | 10 | 248 |
| Preparation Example 4 (P-5800- | 22900 | 11261 | −70.8 | 7.6 | 306 |
| SC) | | | | | |
| Preparation Example 5 (P-5800- | 31856 | 132357 | −66.6 | 13 | 389 |
| SC NS) | | | | | |

As shown in Table 1, each of the supramolecular polymers prepared in Preparation Examples 1 to 5 exhibited a low glass transition temperature of less than −60° C.

The supramolecular polymer of Preparation Example 4 had decreased viscosity, glass transition temperature and melting point and increased thermal decomposition temperature, compared to the supramolecular polymer of Preparation Example 3.

As shown in FIG. 2, in the supramolecular polymer of Preparation Example 3, the peak at 3 to 4 ppm for an alkyl group was upshifted to increase a shielding effect, as compared with that in the supramolecular polymer of Preparation Example 4.

It was determined that the viscosity, glass transition temperature and melting point of the supramolecular polymer of Preparation Example 4 was decreased and the NMR peak for an alkyl group was downshifted because the shielding effect of the alkyl group was decreased due to a decrease in the filling and/or crosslinking degree of the overall chains, as compared with the supramolecular polymer of Preparation Example 3. The viscosity of the supramolecular polymer of Preparation Example 4 was reduced to 1/10 of that of the supramolecular polymer of Preparation Example 3.

It was determined that the supramolecular polymer of Preparation Example 4 had a difference in the three-dimensional structure, such as the specific degree of crosslinking and filling degree, from the supramolecular polymer of Preparation Example 3.

### (Preparation of Polymer Gel Electrolyte)

### Example 1: PC/TFEA (30:70)+LiPF₆+FEC 2 wt %:P-5800=90:10

Propylene carbonate (PC) and 2,2,2-trifluoroethyl acetate (TFEA) were mixed at a volume ratio of 30:70, 1.0 M of LiPF₆ was added, and then 2 wt % of fluoroethylene carbonate (FEC) was added to prepare a liquid electrolyte.

The liquid electrolyte and the supramolecular polymer (P-5800) prepared in Preparation Example 1 were mixed at a weight ratio of 90:10 to prepare a polymer gel electrolyte.

### Example 2: PC/TFEA(30:70)+LiPF₆+FEC 2 wt %:P-4000=90:10

A polymer gel electrolyte was prepared in the same manner as in Preparation Example 1, except that the supramolecular polymer (P-4000) prepared in Preparation Example 2 was used instead of the supramolecular polymer (P-5800) prepared in Preparation Example 1.

### Example 3: PC/TFEA(30:70)+LiPF₆+FEC 2 wt %:P-2000=90:10

A polymer gel electrolyte was prepared in the same manner as in Preparation Example 1, except that the supramolecular polymer (P-2000) prepared in Preparation Example 3 was used instead of the supramolecular polymer (P-5800) prepared in Preparation Example 1.

### Example 4: PC/TFEA(30:70)+LiPF₆+FEC 2 wt %:P-5800-SC=90:10

A polymer gel electrolyte was prepared in the same manner as in Preparation Example 1, except that the supramolecular polymer (P-5800-SC) prepared in Preparation Example 4 was used instead of the supramolecular polymer (P-5800) prepared in Preparation Example 1.

### Example 5: PC/TFEA(30:70)+LiPF₆+VC 2 wt %+HFA 0.25 wt %:P-5800-SC=90:10

Propylene carbonate (PC) and 2,2,2-trifluoroethyl acetate (TFEA) was mixed at a volume ratio of 30:70, 1.0 M of LiPF₆ was added, and 2 wt % of vinylene carbonate (VC) and 0.25 wt % of hexafluoroglutaric anhydride (HFA) were respectively added to prepare a liquid electrolyte.

The liquid electrolyte and the supramolecular polymer (P-5800-SC) prepared in Preparation Example 4 were mixed at a weight ratio of 90:10 to prepare a polymer gel electrolyte.

### Example 6: PC/TFEA(10:90)+LiPF₆+VC 2 wt %+HFA 0.25 wt %:P-5800-SC=90:10

To prepare a polymer gel electrolyte in the same manner as in Example 5, the liquid electrolyte and the supramolecular polymer prepared in Preparation Example 4 were mixed, except that propylene carbonate (PC) and 2,2,2-trifluoroethyl acetate (TFEA) were mixed at a volume ratio of 10:90.

Since the liquid electrolyte and the supramolecular polymer manufactured in Preparation Example 4 were not uniformly mixed, it was impossible to measure physical properties.

### Example 7: PC/TFEA(20:80)+LiPF₆+VC 2 wt %+HFA 0.25 wt %:P-5800-SC=90:10

A polymer gel electrolyte was prepared in the same manner as in Example 5, except that propylene carbonate (PC) and 2,2,2-trifluoroethyl acetate (TFEA) were mixed at a volume ratio of 20:80.

### Example 8: PC/TFEA(20:80)+LiPF₆+VC 2 wt %+HFA 0.25 wt %:P-5800-SC=85:15

A polymer gel electrolyte was prepared in the same manner as in Example 7, except that the liquid electrolyte and the supramolecular polymer (P-5800-SC) prepared in Preparation Example 4 were mixed at a weight ratio of 85:15.

### Example 9: PC/TFEA(20:80)+LiPF₆+VC 2 wt %+HFA 0.25 wt %:P-5800-SC=80:20

A polymer gel electrolyte was prepared in the same manner as in Example 7, except that the liquid electrolyte and the supramolecular polymer (P-5800-SC) prepared in Preparation Example 1 were mixed at a weight ratio of 80:20.

### Example 10: PC/TFEA(20:80)+LiPF₆+VC 2 wt %+HFA 0.25 wt %:P-5800-SC=70:30

A polymer gel electrolyte was prepared in the same manner as in Example 7, except that the liquid electrolyte and the supramolecular polymer (P-5800-SC) prepared in Preparation Example 1 were mixed at a weight ratio of 70:30.

### Example 5-1: PC/TFEP (30:70)+LiPF₆+VC 2 wt %+HFA 0.25 wt %:P-5800-SC=90:10

A polymer gel electrolyte was prepared in the same manner as in Example 5, except that 2,2,2-trifluoroethyl propionate (TFEP) was used instead of 2,2,2-trifluoroethyl acetate (TFEA).

### Example 5-2: PC/TFEFA (30:70)+LiPF₆+VC 2 wt %+HFA 0.25 wt %:P-5800-SC=90:10

A polymer gel electrolyte was prepared in the same manner as in Example 5, except that 2,2,2-trifluoroethyl trifluoroacetate (TFEFA) was used instead of 2,2,2-trifluoroethyl acetate (TFEA).

### Example 5-3: PC/TFEA(30:70)+LiPF₆+VC 2 wt %+HFA 0.25 wt %:P-5800-SC NS=90:10

A polymer gel electrolyte was prepared in the same manner as in Example 5, except that the supramolecular polymer (P-5800-SC NS (No Spacer)) prepared in Preparation Example 5 was used instead of the supramolecular polymer (P-5800-SC) prepared in Preparation Example 4.

### Example 5-4: PC/EMC/TFEA(20:10:70)+LiPF₆+VC 2 wt %+HFA 0.25 wt %:P-5800-SC=90:10

A polymer gel electrolyte was prepared in the same manner as in Example 5, except that propylene carbonate (PC), ethylmethyl carbonate (EMC), and 2,2,2-trifluoroethyl acetate (TFEA) were mixed at a volume ratio of 20:10:70.

### Comparative Example 1: EC/EMC (30:70)+LiPF₆+VC 2 wt %+HFA 0.25 wt %:P-5800-SC=90:10

Ethylene carbonate (EC) and ethyl methyl carbonate (EMC) were mixed at a volume ratio of 30:70, 1.0 M of LiPF₆ was added, and 2 wt % of vinylene carbonate (VC) and 0.25 wt % of hexafluoroglutaric anhydride (HFA) were respectively added to prepare a liquid electrolyte.

The liquid electrolyte and the supramolecular polymer (P-5800-SC) prepared in Preparation Example 4 were mixed at a weight ratio of 90:10 to prepare a polymer gel electrolyte.

### Comparative Example 2: EC/EMC (30:70)+LiPF₆+VC 2 wt %+HFA 0.25 wt %:P-5800-SC=100:0

A polymer gel electrolyte was prepared in the same manner as in Comparative Example 1, except that a supramolecular was not used by mixing the liquid electrolyte and the supramolecular polymer (P-5800-SC) prepared in Preparation Example 4 at a weight ratio of 100:0.

### Comparative Example 3: PC/TFEA(20:80)+LiPF₆+VC 2 wt %+HFA 0.25 wt %:P-5800-SC=100:0

A polymer gel electrolyte was prepared in the same manner as in Example 7, except that a supramolecular was not used by mixing the liquid electrolyte and the supramolecular polymer (P-5800-SC) prepared in Preparation Example 4 at a weight ratio of 100:0.

The compositions of the electrolytes manufactured in Examples 1 to 10, Examples 5-1 to 5-4, and Comparative Examples 1 to 3 are shown in Table 2 below.

TABLE 2

| | | | | Weight ratio of liquid |
|---|---|---|---|---|
| | Solvent | | Supramolecular | electrolyte:supramolecular |
| Electrolyte | (volume ratio) | Additive | polymer | polymer |
| Example 1 | PC:TFEA = 30:70 | FEC 2 wt % | P-5800 | 90:10 |
| Example 2 | PC:TFEA = 30:70 | FEC 2 wt % | P-4000 | 90:10 |
| Example 3 | PC:TFEA = 30:70 | FEC 2 wt % | P-2000 | 90:10 |
| Example 4 | PC:TFEA = 30:70 | FEC 2 wt % | P-5800-SC | 90:10 |
| Example 5 | PC:TFEA = 30:70 | VC 2 wt % + HFA 0.25 wt % | P-5800-SC | 90:10 |
| Example 6 | PC:TFEA = 10:90 | VC 2 wt % + HFA 0.25 wt % | P-5800-SC | 90:10 |
| Example 7 | PC:TFEA = 20:80 | VC 2 wt % + HFA 0.25 wt % | P-5800-SC | 90:10 |
| Example 8 | PC:TFEA = 20:80 | VC 2 wt % + HFA 0.25 wt % | P-5800-SC | 85:15 |
| Example 9 | PC:TFEA = 20:80 | VC 2 wt % + HFA 0.25 wt % | P-5800-SC | 80:20 |
| Example 10 | PC:TFEA = 20:80 | VC 2 wt % + HFA 0.25 wt % | P-5800-SC | 70:30 |
| Comparative | EC:EMC = 30:70 | VC 2 wt % + HFA 0.25 wt % | P-5800-SC | 90:10 |
| Example 1 | | | | |
| Comparative | EC:EMC = 30:70 | VC 2 wt % + HFA 0.25 wt % | — | 100:0 |
| Example 2 | | | | |
| Comparative | PC:TFEA = 20:80 | VC 2 wt % + HFA 0.25 wt % | — | 100:0 |
| Example 3 | | | | |
| Example 5-1 | PC:TFEP = 30:70 | VC 2 wt % + HFA 0.25 wt % | P-5800-SC | 90:10 |
| Example 5-2 | PC:TFEFA = 30:70 | VC 2 wt % + HFA 0.25 wt % | P-5800-SC | 90:10 |
| Example 5-3 | PC:TFEA = 30:70 | VC 2 wt % + HFA 0.25 wt % | P-5800-SC NS | 90:10 |
| Example 5-4 | PC:EMC:TFEA = | VC 2 wt % + HFA 0.25 wt % | P-5800-SC | 90:10 |
| | 20:10:70 | | | |

### Evaluation Example 3: Evaluation of Self-Extinguishing Time, Viscosity and Ionic Conductivity of Polymer Gel Electrolyte

Each of the electrolytes of Examples 1 to 5, Examples 7 to 10, Examples 5-4, and Comparative Examples 1 to 3 was ignited with a torch, and the self-extinguishing time (seconds, SET) per 1 g of the electrolyte was measured after removing the torch.

The non-flammability, flame-retardancy and flammability of the electrolyte according to self-extinguishing time were determined based on the following criteria. SET<6 represents non-flammable, 6≤SET<20 represents flame-retardant, and 20≤SET represents flammable. The measurement results are shown in Table 3 below.

The viscosity of the electrolyte was measured using a viscometer at 25° C. and 1 atm. The measurement results are shown in Table 3 below.

The ionic conductivity of the electrolyte was measured using an impedance analyzer (Bio-Logic SAS). Impedance measurements were performed at 1 atm and 0° C., 25° C., and 45° C., with an amplitude of 10 mV and a frequency range of 0.01 Hz to 105 Hz, respectively. Coin cells for measuring ionic conductivity were assembled by placing electrolyte between stainless steel electrodes. The measurement results are shown in Table 3 below.

TABLE 3

| | | | Ionic | Ionic |
|---|---|---|---|---|
| | Self- | | conductivity | conductivity |
| | extinguishing | Viscosity | [mS/cm] at | [mS/cm] at |
| Electrolyte | time [sec] | [cP] | 0° C. | 25° C. |
| Example 1 | 0 | 22.0 | 2.6 | 3.9 |
| Example 2 | 0 | 14.7 | 2.5 | 3.2 |
| Example 3 | 0 | 13.5 | 2.9 | 5.1 |
| Example 4 | 0 | 19.7 | 2.2 | 2.8 |
| Example 5 | 0 | 19.7 | 2.2 | 2.7 |
| Example 7 | 0 | 17.7 | 2.1 | 2.9 |
| Example 8 | 0 | 18.3 | 1.9 | 2.8 |
| Example 9 | 0 | 19.9 | 1.4 | 2.7 |
| Example 10 | 0 | 24.7 | 1.0 | 1.7 |
| Example 5-4 | 0 | 16.3 | 2.9 | 4.5 |
| Comparative | 31 | 26.0 | 3.5 | 8.7 |
| Example 1 | | | | |
| Comparative | 45 | 3.2 | 4.5 | 6.1 |
| Example 2 | | | | |
| Comparative | 0 | 3.2 | 4.5 | 6.1 |
| Example 3 | | | | |

As shown in Table 3, the polymer gel electrolytes of Examples 1 to 5 and 7 to 10 and 5-4 were non-flammable electrolytes. The polymer gel electrolyte of Comparative Example 1 and the liquid electrolyte of Comparative Example 2 were flammable electrolytes.

The polymer gel electrolytes of Examples 1 to 5 and 7 to 10 and 5-4 exhibited reduced viscosity as compared with the polymer gel electrolyte of Comparative Example 1.

The polymer gel electrolytes of Examples 1 to 5 and 7 to 10 and 5-4 exhibited similar levels of ionic conductivity below 25° C. as compared with the electrolytes of Comparative Examples 1 to 3.

The electrolytes of Comparative Examples 2 and 3 are liquid electrolytes.

### (Lithium Battery)

### Example 11

### (Manufacture of Cathode)

LiNi_{0.8}Co_{0.1}Mn_{0.102} powder and a carbon-based conductive material (Super-P; Timcal Ltd.) were uniformly mixed at a weight ratio of 90:5, and then a polyvinylidene fluoride (PVDF) binder solution was added thereto to prepare a cathode active material slurry having a weight ratio of active material:carbon-based conductive material:binder of 90:5:5. The prepared cathode active material slurry was applied on an aluminum current collector using a doctor blade, dried, and then rolled into a sheet shape using a roll press to manufacture a cathode.

### (Manufacture of Lithium Battery)

Lithium metal foil was used as an anode.

A polyethylene separator was placed between the manufactured cathode and the anode to prepare a laminate. The polymer gel electrolyte prepared in Example 1 was injected into the prepared laminate to manufacture a lithium battery including the polymer gel electrolyte. The lithium battery had a structure of cathode/gel polymer electrolyte (separator)/anode. The lithium battery was a 2016 coin cell.

### Examples 12 to 15 and 17 to 20

A lithium battery was manufactured in the same manner as in Example 11, except that each of the polymer gel electrolytes prepared in Examples 2 to 5 and 7 to 10 was used instead of the polymer gel electrolyte prepared in Example 1.

### Examples 15-1 and 15-2

A lithium battery was manufactured in the same manner as in Example 11, except that each of the polymer gel electrolytes prepared in Examples 5-1 and 5-2 was used instead of the polymer gel electrolyte prepared in Example 1.

### Example 15-3

A lithium battery was manufactured in the same manner as in Example 11, except that the polymer gel electrolyte prepared in Example 5-3 was used instead of the polymer gel electrolyte prepared in Example 1.

### Example 15-4

A lithium battery was manufactured in the same manner as in Example 11, except that the polymer gel electrolyte prepared in Example 5-4 was used instead of the polymer gel electrolyte prepared in Example 1.

### Example 21

### (Manufacture of Cathode)

A cathode was manufactured in the same manner as in Example 11.

### (Manufacture of Anode)

Graphite as an anode active material, styrene-butadiene rubber (SBR) as a binder, and carboxymethyl cellulose (CMC) were mixed at a weight ratio of 98:1:1, and then put into distilled water and mixed to prepare an anode active material slurry. The prepared anode active material slurry was applied on a copper current collector using a doctor blade, dried, and then rolled into a sheet shape using a roll press to manufacture an anode.

### (Manufacture of Lithium Battery)

A polyethylene separator was placed between the manufactured cathode and the manufactured anode to prepare a laminate. The polymer gel electrolyte prepared in Example 5-4 was injected into the prepared laminate to manufacture a lithium battery including the polymer gel electrolyte. The lithium battery had a structure of cathode/gel polymer electrolyte (separator)/anode. The lithium battery was a pouch cell. The design capacity of the lithium battery was 800 mAh.

### Comparative Examples 4 to 6

A lithium battery was manufactured in the same manner as in Example 11, except that the polymer gel electrolyte prepared in Comparative Example 1 and each the liquid electrolytes prepared in Comparative Examples 2 and 3 were used instead of the polymer gel electrolyte prepared in Example 1.

### Comparative Example 7

A lithium battery was manufactured in the same manner as in Example 21, except that the polymer gel electrolyte prepared in Comparative Example 1 was used instead of the polymer gel electrolyte prepared in Example 5-4.

### Evaluation Example 4: Charge/Discharge Test (I)

Charge/discharge tests at high temperature (45° C.) were performed on the lithium batteries of Examples 11 to 14 and Comparative Example 4 under the following conditions.

The lithium battery was charged at a constant current of 0.1 C rate at 45° C. until a voltage reached 4.2 V (vs. Li). Subsequently, the lithium battery was discharged at a constant current of 0.1 C rate until the voltage reached 2.7 V (vs. Li).

This charge/discharge cycle was repeated 20 times. The first cycle is a formation cycle.

In every charge/discharge cycle, a pause of 5 minutes was allowed after each charge/discharge cycle. The results of the high-temperature charge/discharge test are shown in Table 4 below.

The capacity retention rate is defined by the following Equation 1. The initial efficiency is defined by the following Equation 2. The discharge capacity is a discharge capacity at the first cycle.

$$Capacity retention rate [ \% ] = [ Discharge capacity at {20}^{th} cycle / Discharge capacity at {1}^{st} cycle ] \times 100 \qquad < Equation 1 >$$

$$Initial efficiency [ \% ] = [ Discharge capacity at {1}^{st} cycle / Charge capacity at {1}^{st} cycle ] \times 100 \qquad < Equation 2 >$$

TABLE 4

| | Discharge | Capacity | Initial |
|---|---|---|---|
| | capacity | retention | Efficiency |
| | [mAh/g] | rate [%] | [%] |
| Example 11 | 202 | 98 | 93.6 |
| Example 12 | 197 | 95 | 91.9 |
| Example 13 | 194 | 93 | 94.5 |
| Example 14 | 200 | 98 | 92.1 |
| Comparative | 189 | 98 | 91.7 |
| Example 4 | | | |

As shown in Table 4, the lithium batteries of Examples 11 to 14 had improved discharge capacities and initial efficiencies as compared with the lithium battery of Comparative Example 4.

The lithium batteries of Examples 11 to 14 provided similar lifespan characteristics to the lithium battery of Comparative Example 4.

The lithium batteries of Examples 11 to 14, unlike the lithium battery of Comparative Example 4, are non-flammable lithium batteries because they include a non-flammable polymer gel electrolyte.

### Evaluation Example 5: Charge/Discharge Test (II)

Charge/discharge tests at high temperature (45° C.) were performed on the lithium batteries of Examples 15 and 17 and Comparative Example 4 under the following conditions.

The lithium battery was charged at a constant current of 0.1 C rate at 45° C. until a voltage reached 4.2 V (vs. Li). Subsequently, the lithium battery was discharged at a constant current of 0.1 C rate until the voltage reached 2.7 V (vs. Li).

This charge/discharge cycle was repeated 50 times. The first cycle is a formation cycle.

In every charge/discharge cycle, a pause of 5 minutes was allowed after each charge/discharge cycle. The results of the high-temperature charge/discharge test are shown in Table 5 below.

The capacity retention rate is defined by the following Equation 3. The initial efficiency is defined by the following Equation 2. The discharge capacity is a discharge capacity at the first cycle.

$$Capacity retention rate [ \% ] = [ Discharge capacity at {50}^{th} cycle / Discharge capacity at {1}^{st} cycle ] \times 100 \qquad < Equation 3 >$$

$$Initial efficiency [ \% ] = [ Discharge capacity at {1}^{st} cycle / Charge capacity at {1}^{st} cycle ] \times 100 \qquad < Equation 2 >$$

TABLE 5

| | Discharge | Capacity | Initial |
|---|---|---|---|
| | capacity | retention | Efficiency |
| | [mAh/g] | rate [%] | [%] |
| Example 15 | 200 | 94 | 92.0 |
| Example 17 | 203 | 96 | 94.2 |
| Comparative | 189 | 92 | 91.7 |
| Example 4 | | | |

As shown in Table 5, the lithium batteries of Examples 15 and 17 had improved discharge capacity, lifespan characteristics and initial efficiency as compared with the lithium battery of Comparative Example 4.

The lithium batteries of Examples 15 and 17, unlike the lithium battery of Comparative Example 4, are non-flammable lithium batteries because they include a non-flammable polymer gel electrolyte.

### Evaluation Example 6: Charge/Discharge Test (III)

Charge/discharge tests at high temperature (45° C.) were performed on the lithium batteries of Examples 17 to 20 under the following conditions.

The lithium battery was charged at a constant current of 0.1 C rate at 45° C. until a voltage reached 4.2 V (vs. Li). Subsequently, the lithium battery was discharged at a constant current of 0.1 C rate until the voltage reached 2.7 V (vs. Li).

This charge/discharge cycle was repeated 50 times. The first cycle is a formation cycle.

In every charge/discharge cycle, a pause of 5 minutes was allowed after each charge/discharge cycle.

The capacity retention rate is defined by the following Equation 3. The initial efficiency is defined by the following Equation 2. The discharge capacity is a discharge capacity at the first cycle.

$$Capacity retention rate [ \% ] = [ Discharge capacity at {50}^{th} cycle / Discharge capacity at {1}^{st} cycle ] \times 100 \qquad < Equation 3 >$$

$$Initial efficiency [ \% ] = [ Discharge capacity at {1}^{st} cycle / Charge capacity at {1}^{st} cycle ] \times 100 \qquad < Equation 2 >$$

The discharge capacity, lifespan characteristics and initial efficiency of the lithium battery of Example 17 were the best.

The discharge capacities and lifespan characteristics of the lithium batteries of Examples 17 to 20 had the following relative order: Example 17>Example 18>Example 19>Example 20

The initial efficiencies of the lithium batteries of Examples 17 to 20 had the following relative order: Example 17>Example 18>Example 20>Example 19

The lithium batteries of Examples 17 to 20 are non-flammable lithium batteries including a non-flammable polymer gel electrolyte.

### Evaluation Example 7: Charge/Discharge Test (IV)

Charge/discharge tests at high temperature (45° C.) were performed on the lithium batteries of Example 17 and Comparative Examples 4 to 6 under the following conditions.

The lithium battery was charged at a constant current of 0.1 C rate at 45° C. until a voltage reached 4.2 V (vs. Li). Subsequently, the lithium battery was discharged at a constant current of 0.1 C rate until the voltage reached 2.7 V (vs. Li).

This charge/discharge cycle was repeated 100 times. The first cycle is a formation cycle.

In every charge/discharge cycle, a pause of 5 minutes was allowed after each charge/discharge cycle. The results of the high-temperature charge/discharge test are shown in Table 6 below.

The capacity retention rate is defined by the following Equation 4. The initial efficiency is defined by the following Equation 2. The discharge capacity is a discharge capacity at the first cycle.

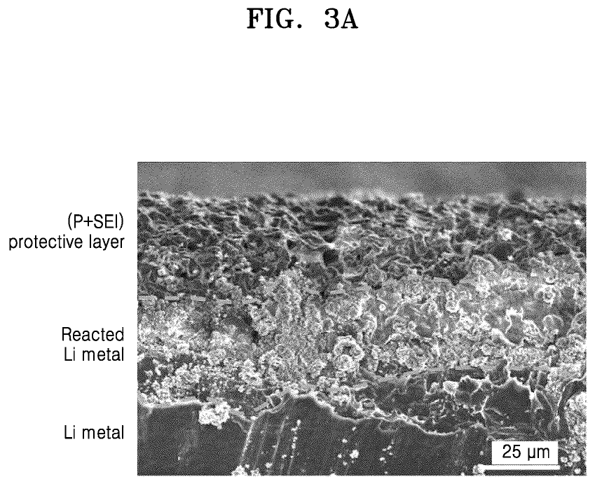

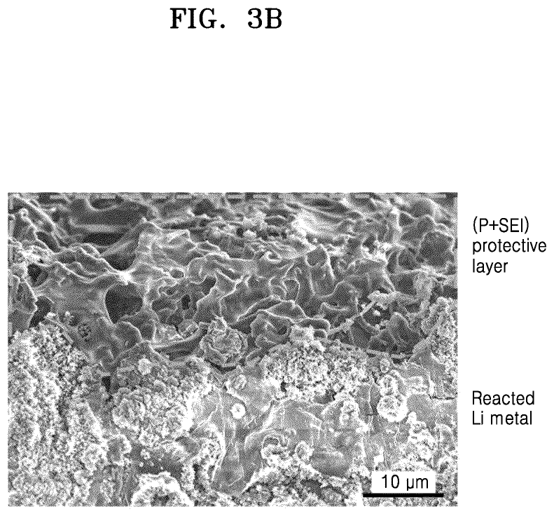

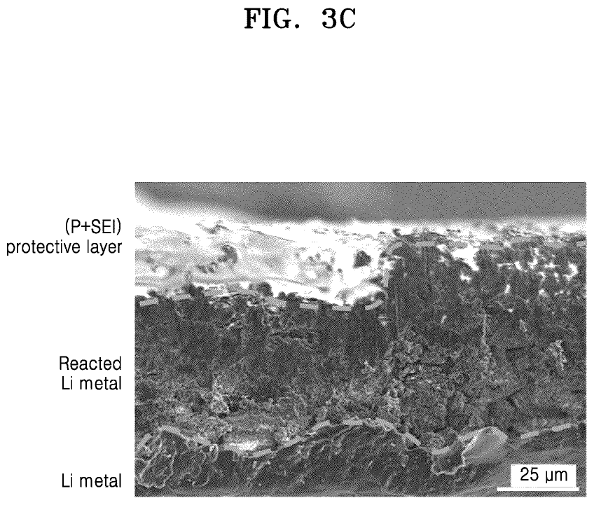

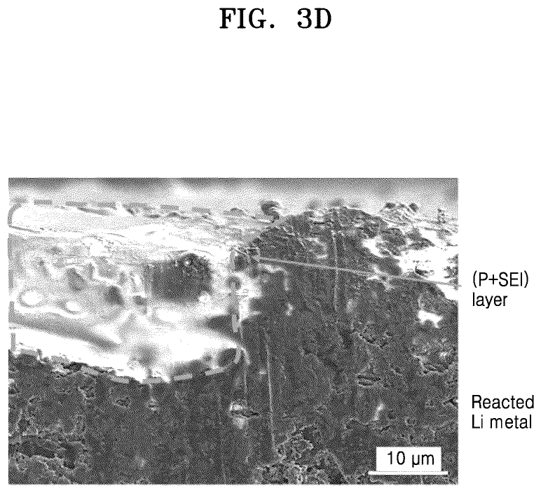

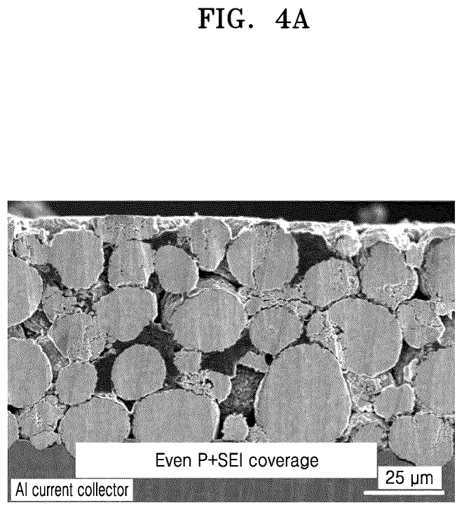

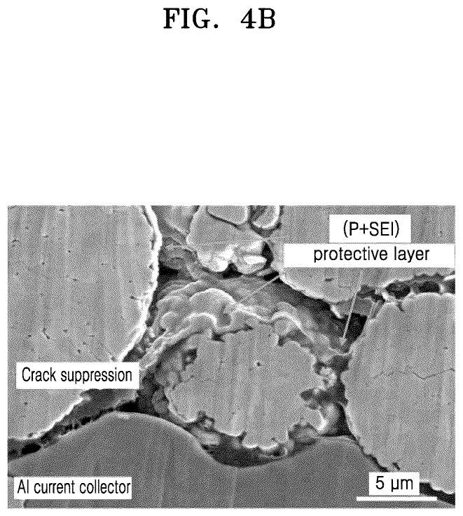

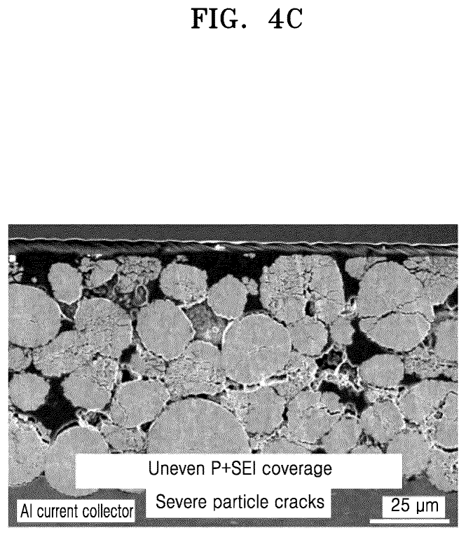

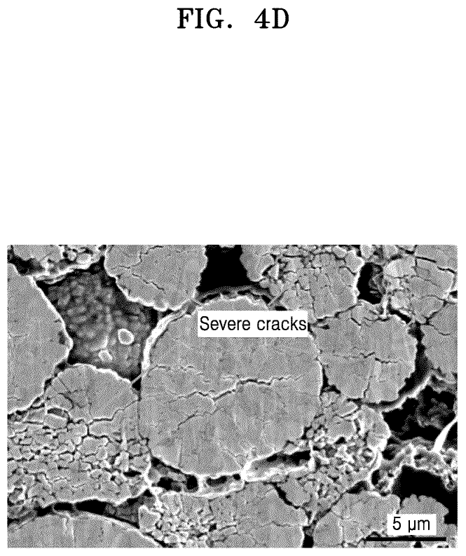

After 100 charge/discharge cycles, the cross-sections of the cathodes and anodes of the lithium batteries of Example 17 and Comparative Example 4 were measured using a scanning electron microscope (SEM), and the results thereof are shown in FIGS. 3A to 4D.

FIG. 3A shows a cross-sectional image of the anode of Example 17 after 100 charge-discharge cycles. FIG. 3B is a partially enlarged view of FIG. 3A.

FIG. 3C shows a cross-sectional image of the anode of Comparative Example 4 after 100 charge-discharge cycles. FIG. 3D is a partially enlarged view of FIG. 3C.

FIG. 4A shows a cross-sectional image of the cathode of Example 17 after 100 charge-discharge cycles. FIG. 4B is a partially enlarged view of FIG. 4A.

FIG. 4C shows a cross-sectional image of the cathode of Comparative Example 4 after 100 charge-discharge cycles. FIG. 4D is a partially enlarged view of FIG. 4C.

$$Capacity retention rate [ \% ] = [ Discharge capacity at {100}^{th} cycle / Discharge capacity at {1}^{st} cycle ] \times 100 \qquad < Equation 4 >$$

$$Initial efficiency [ \% ] = [ Discharge capacity at {1}^{st} cycle / Charge capacity at {1}^{st} cycle ] \times 100 \qquad < Equation 2 >$$

TABLE 6

| | Discharge | Capacity | Initial |
|---|---|---|---|
| | capacity | retention | efficiency |
| | [mAh/g] | rate [%] | [%] |
| Example 17 | 203 | 82 | 94.2 |
| Comparative | 189 | 75 | 91.7 |
| Example 4 | | | |
| Comparative | 204 | 34 | 93.3 |
| Example 5 | | | |
| Comparative | 205 | 57 | 95.5 |
| Example 6 | | | |

As shown in Table 6, the lithium battery of Example 17 had improved discharge capacity, lifespan characteristics and initial efficiency as compared with the lithium batteries of Comparative Examples 4 to 6.

The lithium battery of Example 17 including the polymer gel electrolyte of Example 7 had improved lifespan characteristics as compared with the lithium battery of Comparative Example 4 including the polymer gel electrolyte of Comparative Example 1, the lithium battery of Comparative Example 5 including the liquid electrolyte of Comparative Example 2, and the lithium battery of Comparative Example 6 including the liquid electrolyte of Comparative Example 3.

As shown in FIGS. 3A and 3B, a polymer-containing solid electrolyte film (SEI) having high coverage and even thickness was formed on a lithium metal after 100 charge/discharge cycles in the lithium battery of Example 17.

In contrast, as shown in FIGS. 3C to 3D, a polymer-containing solid electrolyte film (SEI) having low coverage and uneven thickness was formed on the lithium metal after 100 charge/discharge cycles in the lithium battery of Comparative Example 4.

Therefore, it was determined that the lithium battery of Example 17 could more effectively suppress the formation of lithium dendrites on the anode during the charge/discharge process as compared with the lithium battery of Comparative Example 4, thereby more effectively suppressing the deterioration of the lithium battery.

As shown in FIGS. 4A and 4B, a polymer-containing solid electrolyte film (SEI) having high coverage and even thickness was formed on the cathode active material particles after 100 charge/discharge cycles in the lithium battery of Example 17. Additionally, the formation of cracks within the cathode active material particles was suppressed.

In contrast, as shown in FIGS. 4C to 4D, a polymer-containing solid electrolyte film (SEI) having low coverage and uneven thickness was formed on the cathode active material particles after 100 charge/discharge cycles in the lithium battery of Comparative Example 4. Additionally, the formation of cracks within the cathode active material particles was significantly increased.

Therefore, it was determined that the lithium battery of Example 17 could suppress the surface side reactions of the cathode active material particles in the cathode during the charge/discharge process, suppress the electrical disconnection between the cathode active material particles, and suppress the elution of transition metals from the surface of the cathode active material particles, as compared with the lithium battery of Comparative Example 4, thereby more effectively suppressing the deterioration in performance of the lithium battery.

The lithium battery of Example 17 is a non-flammable lithium battery because it includes a non-flammable polymer gel electrolyte. In contrast, the lithium batteries of Comparative Examples 4 and 5 are flammable lithium batteries including a flammable electrolyte.

### Evaluation Example 8: Charge/Discharge Test (V)

Charge/discharge tests at high temperature (45° C.) were performed on the lithium batteries of Examples 15, 15-1 and 15-2 under the following conditions.

The lithium battery was charged at a constant current of 0.1 C rate at 45° C. until a voltage reached 4.2 V (vs. Li). Subsequently, the lithium battery was discharged at a constant current of 0.1 C rate until the voltage reached 2.7 V (vs. Li).

This charge/discharge cycle was repeated 30 times. The first cycle is a formation cycle.

In every charge/discharge cycle, a pause of 5 minutes was allowed after each charge/discharge cycle. The results of the high-temperature charge/discharge test are shown in Table 7 below.

The capacity retention rate is defined by the following Equation 5. The initial efficiency is defined by the following Equation 2. The discharge capacity is a discharge capacity at the first cycle.

$$Capacity retention rate [ \% ] = [ Discharge capacity at {30}^{th} cycle / Discharge capacity at {1}^{st} cycle ] \times 100 \qquad < Equation 5 >$$

$$Initial efficiency [ \% ] = [ Discharge capacity at {1}^{st} cycle / Charge capacity at {1}^{st} cycle ] \times 100 \qquad < Equation 2 >$$

TABLE 7

| | Discharge | Capacity | Initial |
|---|---|---|---|
| | capacity | retention | efficiency |
| | [mAh/g] | rate [%] | [%] |
| Example 15 | 200 | 97 | 92.0 |
| Example 15-1 | 188 | 97 | 90.4 |
| Example 15-2 | 195 | — | 91.0 |

As shown in Table 7, the lithium batteries of Examples 15, 15-1 and 15-2 including fluorine-containing ester solvents exhibited excellent discharge capacity and initial efficiency.

### Evaluation Example 9: Charge/Discharge Test (VI)

Charge/discharge tests at high temperature (45° C.) were performed on the lithium batteries of Examples 15 and 15-3 under the following conditions.

The lithium battery was charged at a constant current of 0.1 C rate at 45° C. until a voltage reached 4.2 V (vs. Li). Subsequently, the lithium battery was discharged at a constant current of 0.1 C rate until the voltage reached 2.7 V (vs. Li).

This charge/discharge cycle was repeated 30 times. The first cycle is a formation cycle.

In every charge/discharge cycle, a pause of 5 minutes was allowed after each charge/discharge cycle. The results of the high-temperature charge/discharge test are shown in Table 8 below.

The capacity retention rate is defined by the following Equation 5. The initial efficiency is defined by the following Equation 2. The discharge capacity is a discharge capacity at the first cycle.

$$Capacity retention rate [ \% ] = [ Discharge capacity at {30}^{th} cycle / Discharge capacity at {1}^{st} cycle ] \times 100 \qquad < Equation 5 >$$

$$Initial efficiency [ \% ] = [ Discharge capacity at {1}^{st} cycle / Charge capacity at {1}^{st} cycle ] \times 100 \qquad < Equation 2 >$$

TABLE 8

| | Discharge | Capacity | Initial |
|---|---|---|---|
| | capacity | retention | efficiency |
| | [mAh/g] | rate [%] | [%] |
| Example 15 | 200 | 97 | 92.0 |
| Example 15-3 | 192 | 97 | 90.7 |

As shown in Table 8, the lithium battery of Example 15 including the supramolecular polymer including a spacer had relatively superior discharge capacity and initial efficiency as compared with the lithium battery of Example 15-3 including the supramolecular polymer not including a spacer.

### Evaluation Example 10: Charge/Discharge Test (VII)

Charge/discharge tests at high temperature (45° C.) were performed on the lithium batteries of Examples 17 and 15-4 and Comparative Example 4 under the following conditions.

The lithium battery was charged at a constant current of 0.2 C rate at 45° C. until a voltage reached 4.2 V. Subsequently, the lithium battery was discharged at a constant current of 0.1 C rate until the voltage reached 3.0 V (vs. Li).

This charge/discharge cycle was repeated 200 times. The first cycle is a formation cycle.

In every charge/discharge cycle, a pause of 5 minutes was allowed after each charge/discharge cycle. The results of the high-temperature charge/discharge test are shown in Table 9 below.

The capacity retention rate is defined by the following Equation 6. The initial efficiency is defined by the following Equation 2. The discharge capacity is a discharge capacity at the first cycle.

$$Capacity retention rate [ \% ] = [ Discharge capacity at {200}^{th} cycle / Discharge capacity at {1}^{st} cycle ] \times 100 \qquad < Equation 6 >$$

$$Initial efficiency [ \% ] = [ Discharge capacity at {1}^{st} cycle / Charge capacity at {1}^{st} cycle ] \times 100 \qquad < Equation 2 >$$

TABLE 9

| | Discharge | Capacity | Initial |
|---|---|---|---|
| | capacity | retention | efficiency |
| | [mAh/g] | rate [%] | [%] |
| Example 17 | 195 | 51 | 92.0 |
| Example 15-4 | 192 | 73 | 91.4 |
| Comparative | 185 | 6 (100^{th} cycle) | 91.3 |
| Example 4 | | | |

As shown in Table 9, the lithium batteries of Examples 17 and 15-4 had improved discharge capacity, lifespan characteristics and initial efficiency as compared with the lithium battery of Comparative Example 4.

The lithium battery of Example 15-4 including a linear carbonate solvent exhibited particularly improved lifespan characteristics.

Evaluation Example 11: Charge/Discharge Test (VIII) and Thermal Runaway Temperature Measurement

Charge/discharge tests at high temperature (45° C.) were performed on the lithium batteries of Example 21 and Comparative Example 7 under the following conditions.

The lithium battery was charged at a constant current of 0.1 C rate at 45° C. until a voltage reached 4.2 V, and then charged at a constant voltage at 4.2 V. Subsequently, the lithium battery was discharged at a constant current of 0.1 C rate until the voltage reached 3.0 V (vs. Li).

This charge/discharge cycle was repeated 100 times. The first cycle is a formation cycle.

In every charge/discharge cycle, a pause of 5 minutes was allowed after each charge/discharge cycle. The results of the high-temperature charge/discharge test are shown in Table 10 below.

The capacity retention rate is defined by the following Equation 4. The initial efficiency is defined by the following Equation 2. The discharge capacity is a discharge capacity at the first cycle.

$$Capacity retention rate [ \% ] = [ Discharge capacity at {100}^{th} cycle / Discharge capacity at {1}^{st} cycle ] \times 100 \qquad < Equation 4 >$$

$$Initial efficiency [ \% ] = [ Discharge capacity at {1}^{st} cycle / Charge capacity at {1}^{st} cycle ] \times 100 \qquad < Equation 2 >$$

To evaluate the safety of the lithium batteries, thermal runaway temperature was measured using an accelerating rate calorimeter (ARC). The measurement results are shown in Table 10 below.

TABLE 10

| | | Capacity | | Thermal |
|---|---|---|---|---|
| | Discharge | retention | Initial | runaway |
| | capacity | rate | efficiency | temperature |
| | [mAh] | [%] | [%] | [° C.] |
| Example 21 | 717 | 86 | 92.2 | 205 |
| Comparative | 688 | 82 | 88.5 | 187 |
| Example 7 | | | | |

As shown in Table 10, the lithium battery of Example 21 had improved discharge capacity, lifespan characteristics and initial efficiency as compared with the lithium battery of Comparative Example 7.

The thermal runaway temperature of the lithium battery of Example 21 was 205° C., which showed improved thermal stability as the thermal runaway temperature thereof increased by 18° C. compared to the thermal runaway temperature of the lithium battery of Comparative Example 7.

It was confirmed that a polymer gel electrolyte according to an embodiment exhibits improved thermal stability in various lithium batteries, such as lithium metal batteries using lithium metal as an anode and lithium ion batteries using graphite as an anode, and from this, it was found that improvement in lithium battery safety is possible.

According to an aspect, it is possible to provide a flame-retardant or non-flammable polymer gel electrolyte which simultaneously provides reduced ignition possibility, excellent ionic conductivity and low viscosity. According to another aspect, it is possible to provide a lithium battery having improved charge/discharge characteristics and improved safety by employing the above-described flame retardant or non-flammable polymer gel electrolyte.

According to another aspect, it is possible to provide a supramolecular polymer that can simultaneously provide ionic conductivity and mechanical properties.

According to another aspect, it is possible to provide a new method of preparing a supramolecular polymer, the method being capable of preparing supramolecular polymers having different properties depending on the content of a solvent.

Although exemplary embodiments have been described in detail with reference to the attached drawings, the present creative idea is not limited thereto.

It is obvious that a person with ordinary knowledge in the technical field to which the present creative idea belongs can derive various examples of changes or modifications within the scope of the technical idea described in the patent claims, and these also naturally belong to the technical scope of the present creative idea.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A flame-retardant or non-flammable polymer gel electrolyte comprising:
a supramolecular polymer;
a carbonate-based solvent;
a fluorine-containing linear ester-based solvent; and
a lithium salt,
wherein the supramolecular polymer includes a hard segment and a soft segment,
the hard segment and the soft segment are connected by a urethane bond, a urea bond or a combination thereof,
the soft segment includes an alkylene oxide repeating unit, and
the supramolecular polymer has a glass transition temperature (Tg) of less than 0° C.

2. The flame-retardant or non-flammable polymer gel electrolyte of claim 1, wherein
wherein the hard segment includes an aromatic ring, an aliphatic ring or a combination thereof, and
each of the aromatic ring and aliphatic ring has a skeleton including carbon atoms.

3. The flame-retardant or non-flammable polymer gel electrolyte of claim 1, wherein
the alkylene oxide repeating unit includes an ethylene oxide repeating unit, a propylene oxide repeating unit, a butylene oxide repeating unit, or a combination thereof.

4. The flame-retardant or non-flammable polymer gel electrolyte of claim 1, wherein
the supramolecular polymer further includes a spacer, and the spacer includes an alkylene oxide repeating unit.

5. The flame-retardant or non-flammable polymer gel electrolyte of claim 1, wherein
the supramolecular polymer includes at least one selected from a repeating unit represented by Formula 1 below, a compound represented by Formula 2 below, a repeating unit derived from the compound represented Formula 2, and a reaction product derived from the compound represented by Formula 2: 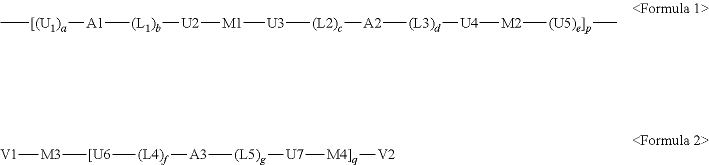
wherein, in Formulae 1 and 2,
M1, M2, M3 and M4 are each independently an arylene group selected from arylene groups represented by Formulae 3a to 3d below or a cycloalkylene group selected from cycloalkylene groups represented by Formulae 3e to 3g below,
U1, U2, U3, U4, U5, U6 and U7 are each independently —NH—C(═O)O—, —OC(═O)—NH—, —C(═O)—NH—, —NH—C(═O)—, —NH—C(═O)—NH—, —NH—, or —O—,
V1 and V2 are each independently an isocyanate group,
L1, L2, L3, L4 and L5 are each independently a C2-C5 alkylene group,
A1, A2 and A3 are each independently a C2-C5 alkylene oxide repeating unit,
a, b, c, d, e, f and g are independently 0 or 1, 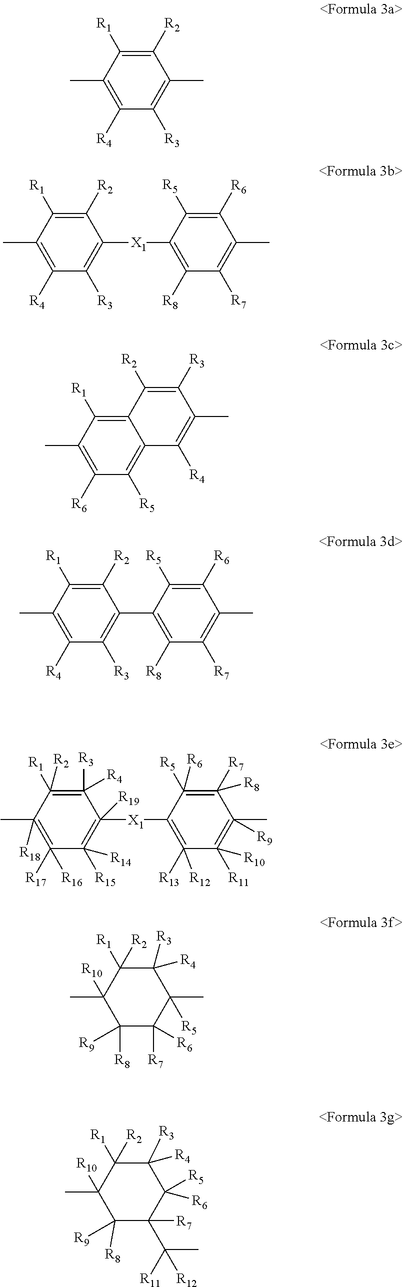
wherein, in Formulae 3a to 3g,
R₁, R₂, R₃, R₄, R₅, R₆, R₇, R₈, R₉, R₁₀, R₁₁, R₁₂, R₁₃, R₁₄, R₁₅, R₁₆, R₁₇, R₁₈, R₁₉ and R₂₀ are each independently hydrogen, a halogen, a hydroxyl group, or a C1-C10 alkyl group unsubstituted or substituted with a halogen,
X₁ is —CH₂—, —CH₂CH₂—, —CH₂CH₂CH₂—, —CH₂CH₂CH₂CH₂—, —O—, —C(═O)—, —S—, or —C(═S)—,
p is a polymerization degree of 2 to 1000, and
q is a polymerization degree of 1 to 1000.

6. The flame-retardant or non-flammable polymer gel electrolyte of claim 1, wherein L1, L2, L3, L4 and L5 are each independently —CH₂CH₂—, —CH₂CH₂CH₂—, or —CH₂CH(CH₃)—,
A1, A2 and A3 are each independently —(CH₂CH₂O)ₙ₁—, —(CH₂CH(CH₃)O)ₙ₂—, —(CH₂CH₂)ₙ₃—(CH₂CH(CH₃)O)ₙ₄—, —(CH₂CH₂)ₙ₅—(CH₂CH(CH₃)O)ₙ₆—(CH₂CH₂)ₙ₇—, or —(CH₂CH(CH₃)O)ₙ₈—(CH₂CH₂)ₙ₉—(CH₂CH(CH₃)O)ₙ₁₀—, and
n1, n2, n3, n4, n5, n6, n7, n8, n9 and n10 are each independently 2 to 500.

7. The flame-retardant or non-flammable polymer gel electrolyte of claim 1, wherein M1 and M2 are each independently an arylene group selected from arylene groups represented by Formulae 4a to 4d below or a cycloalkylene group selected from cycloalkylene groups represented by Formulae 4e to 4g:

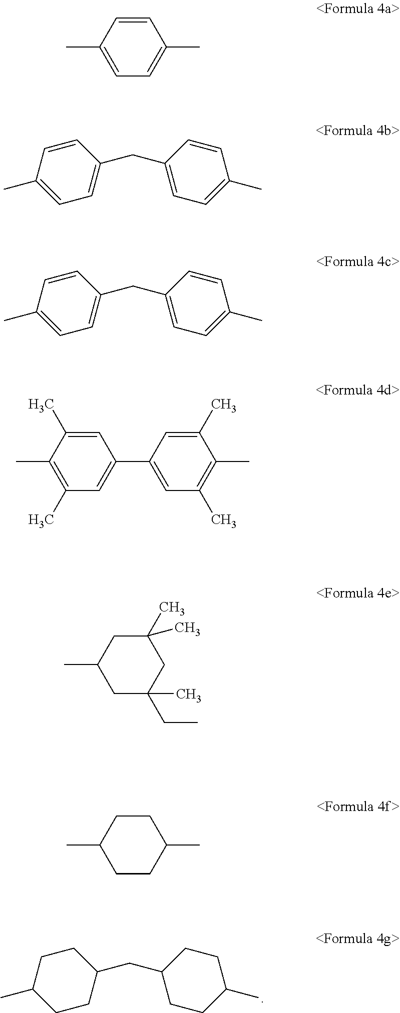

8. The flame-retardant or non-flammable polymer gel electrolyte of claim 1, wherein
the supramolecular polymer includes a repeating unit represented by Formula 5 below, a repeating unit represented by Formula 7 below, a compound represented by Formula 6 below, or a compound represented by Formula 8 below: 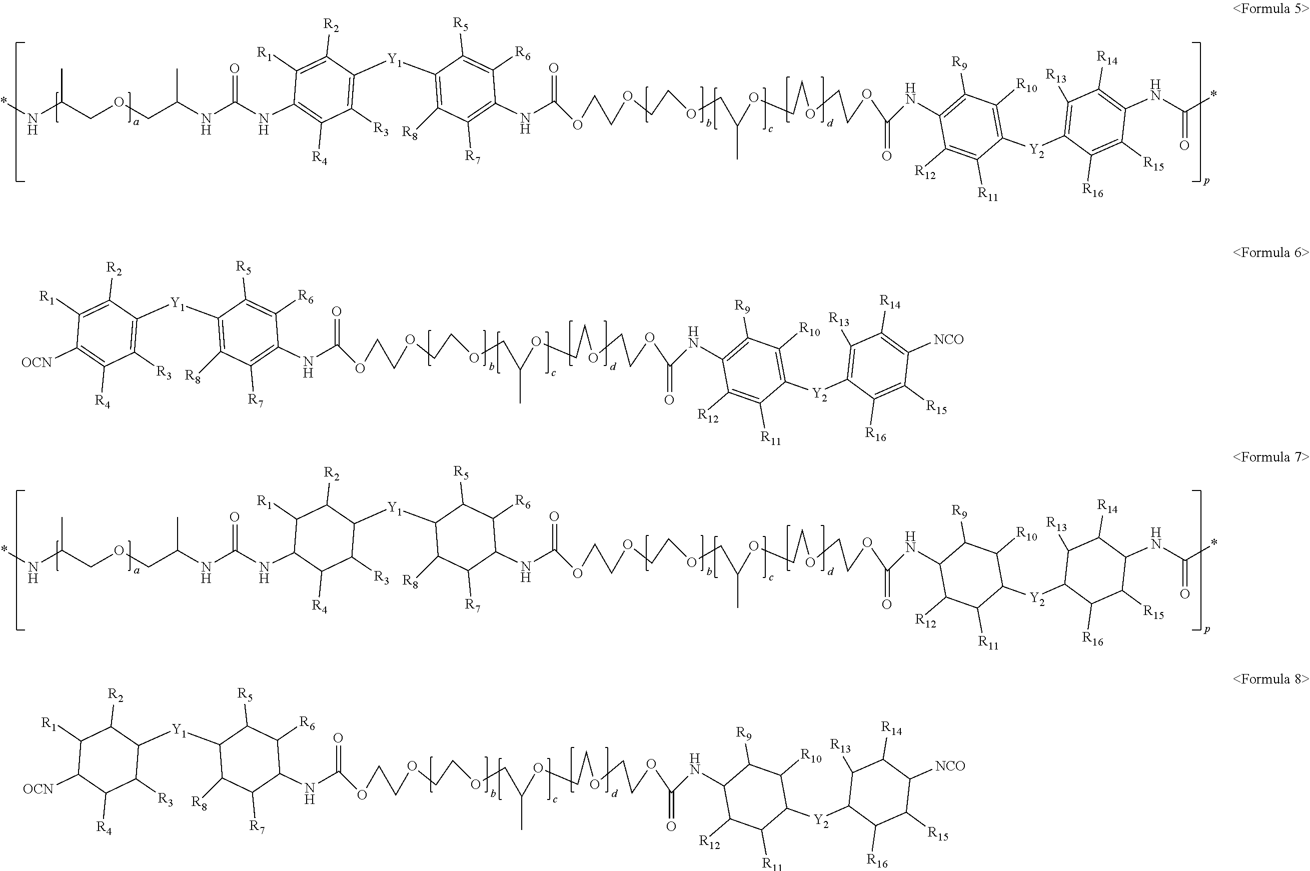
wherein, in Formulae 5 to 8,
R₁, R₂, R₃, R₄, R₅, R₆, R₇, R₈, R₉, R₁₀, R₁₁, R₁₂, R₁₃ and R₁₄ are each independently hydrogen, a halogen, a hydroxyl group, or a C1-C5 alkyl group unsubstituted or substituted with a halogen,
Y₁ and Y₂ are each independently a single bond, —CH₂—, —CH₂CH₂—, —CH₂CH₂CH₂—, —CH₂CH₂CH₂CH₂—, —O—, —C(═O)—, —S—, or —C(═S)—,
A, B, C and D are each independently 2 to 500, and
p is a polymerization degree of 2 to 1000.

9. The flame-retardant or non-flammable polymer gel electrolyte of claim 1, wherein
the supramolecular polymer has a weight average molecular weight of 5,000 Daltons to 500,000 Daltons.

10. The flame-retardant or non-flammable polymer gel electrolyte of claim 1, wherein
the supramolecular polymer has a glass transition temperature (Tg) of −55° C. or less.

11. The flame-retardant or non-flammable polymer gel electrolyte of claim 1, wherein
a content of the supramolecular polymer is about 1 wt % to about 50 wt % based on a total weight of the polymer gel electrolyte.

12. The flame-retardant or non-flammable polymer gel electrolyte of claim 1, wherein
the carbonate-based solvent includes a fluorine-containing cyclic carbonate-based solvent, a fluorine-free cyclic carbonate-based solvent, a fluorine-containing linear carbonate-based solvent, a fluorine-free linear carbonate-based solvent, or a combination thereof.

13. The flame-retardant or non-flammable polymer gel electrolyte of claim 1, wherein
the fluorine-containing linear ester-based solvent is represented by Formula 15 below: 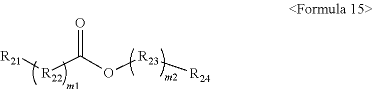
wherein, in Formula 15,
R₂₁ and R₂₄ are each independently a C1 to C5 alkyl group substituted or unsubstituted with a halogen,
R₂₂ and R₂₃ are each independently a C1 to C5 alkylene group substituted or unsubstituted with a halogen,
at least one of R₂₁, R₂₂, R₂₃ and R₂₄ includes fluorine, and
m1 and m2 are each independently an integer of 0 to 5.

14. The flame-retardant or non-flammable polymer gel electrolyte of claim 1, wherein
the fluorine-containing linear ester-based solvent includes fluoromethyl acetate, difluoromethyl acetate, trifluoromethyl acetate, 2-fluoroethyl acetate, 2,2-difluoroethyl acetate, 2,2,2-trifluoroethyl acetate (TFEA), 2,2,2-trifluoroethyl trifluoroacetate (TFEFA), fluoromethyl propionate, difluoromethyl propionate, trifluoromethyl propionate, 2-fluoroethyl propionate, 2,2-difluoroethyl propionate, 2,2,2-trifluoroethyl propionate (TFEP), 2-fluoroethyl butyrate, 2,2-difluoroethyl butyrate, 2,2,2-trifluoroethyl butyrate (TFEB), or a combination thereof.

15. The flame-retardant or non-flammable polymer gel electrolyte of claim 1, wherein
a mixing volume ratio of the carbonate-based solvent and the fluorine-containing linear ester-based solvent is about 10:90 to about 95:5.

16. The flame-retardant or non-flammable polymer gel electrolyte of claim 1, further comprising:
an additive,
wherein the additive includes vinylene carbonate (VC), fluoroethylene carbonate (FEC), hexafluoroglutaric anhydride (HFA), pentafluoropropionic anhydride (PFPA), vinylene ethylene carbonate (VEC), pentaerythritol disulfate (PEDS), propane sultone (PS), ethylene sulfate (ES), LiPO₂F₂, LiNO₃, or a combination thereof.

17. The flame-retardant or non-flammable polymer gel electrolyte of claim 1, wherein
the flame-retardant or non-flammable polymer gel electrolyte has a self-extinguishing time of less than 20 sec/g.

18. A lithium battery comprising:
a cathode; an anode; and an electrolyte layer between the cathode and the anode,
wherein the electrolyte layer includes the flame-retardant or non-flammable polymer gel electrolyte of claim 1.

19. A supramolecular polymer comprising
at least one selected from a repeating unit represented by Formula 1 below, a compound represented by Formula 2 below, a repeating unit derived from the compound represented Formula 2, and a reaction product derived from the compound represented by Formula 2: 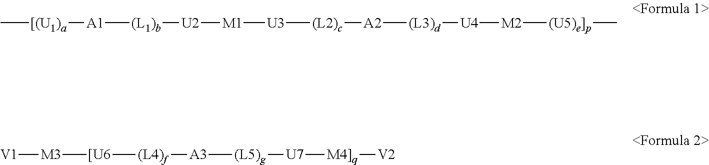
wherein, in Formulae 1 and 2,
M1, M2, M3 and M4 are each independently an arylene group selected from arylene groups represented by Formulae 3a to 3d below or a cycloalkylene group selected from cycloalkylene groups represented by Formulae 3e to 3g below,
U1, U2, U3, U4, U5, U6 and U7 are each independently —NH—C(═O)O—, —OC(═O)—NH—, —C(═O)—NH—, —NH—C(═O)—, —NH—C(═O)—NH—, —NH—, or —O—,
V1 and V2 are each independently an isocyanate group,
L1, L2, L3, L4 and L5 are each independently a C2-C5 alkylene group,
A1, A2 and A3 are each independently a C2-C5 alkylene oxide repeating unit,
a, b, c, d, e, f and g are each independently 0 or 1, 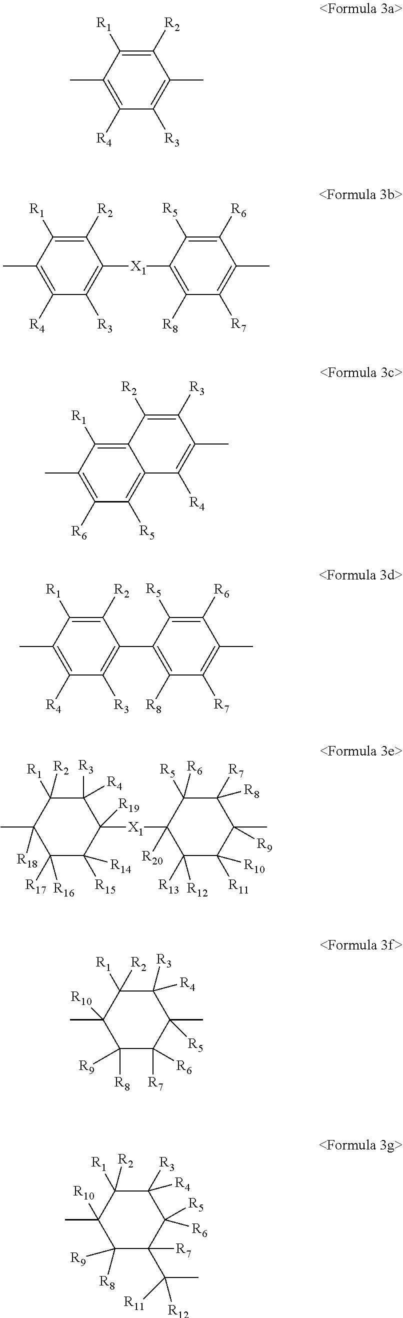
wherein, in Formulae 3a to 3g,
R₁, R₂, R₃, R₄, R₅, R₆, R₇, R₈, R₉, R₁₀, R₁₁, R₁₂, R₁₃, R₁₄, R₁₅, R₁₆, R₁₇, R₁₈, R₁₉ and R₂₀ are each independently hydrogen, a halogen, a hydroxyl group, or a C11-C10 alkyl group unsubstituted or substituted with a halogen,
X₁ is —CH₂—, —CH₂CH₂—, —CH₂CH₂CH₂—, —CH₂CH₂CH₂CH₂—, —O—, —C(═O)—, —S—, or —C(═S)—, and
p is a polymerization degree of 2 to 1000.

20. A method of preparing a supramolecular polymer, the method comprising:
reacting a first precursor compound including a soft segment, a first solution including a first solvent, and a second precursor compound including a hard segment to prepare a prepolymer; and
reacting a third precursor compound including a spacer, a second solution including a second solvent, and the prepolymer to prepare a supramolecular polymer,
wherein the first solvent and the second solvent have a first volume ratio in which 70 parts by volume or less of the second solvent is included with respect to 100 parts by volume of the first solvent, or a second volume ratio in which 80 parts by volume or more of the second solvent is included with respect to 100 parts by volume of the first solvent, and
viscosity of a first supramolecular polymer prepared by the first volume ratio is 50% or less of viscosity of a second supramolecular polymer prepared by the second volume ratio.
